(19) United States
(12) Patent Application Publication
(10) Pub. No.: US 2025/0148719 A1
(43) Pub. Date: May 8, 2025

(54) PARTIAL SUBDIVISION SURFACES

(71) Applicant: Baobab Studios Inc., Redwood City, CA (US)

(72) Inventor: Lawrence David Cutler, San Francisco, CA (US)

(21) Appl. No.: 18/603,038

(22) Filed: Mar. 12, 2024

Related U.S. Application Data
(60) Provisional application No. 63/597,164, filed on Nov. 8, 2023.

(51) Int. Cl. G06T 17/20; G06T 7/12; G06T 7/13; G06T 13/20

(52) U.S. Cl. CPC G06T 17/205; G06T 7/12; G06T 7/13; G06T 13/20

(57) ABSTRACT

Systems, methods, and non-transitory computer-readable media can determine data associated with a mesh of a three-dimensional object and generate a partially subdivided mesh based on the mesh and the data.

### CROSS-REFERENCE TO RELATED APPLICATIONS

This application claims priority to U.S. Provisional Patent Application No. 63/597,164, filed on Nov. 8, 2023, and entitled “PARTIAL SUBDIVISION SURFACES,” which is incorporated herein by reference in its entirety.

### FIELD OF THE INVENTION

The present technology relates to the field of digital animation. More particularly, the present technology relates to techniques for real-time digital animation utilizing partially subdivided surfaces.

### BACKGROUND

Virtual reality (VR) and augmented reality (AR) are new media for entertainment and storytelling that enable content creators to immerse the viewer in ways that are not possible in other media. VR and AR are powerful immersive platforms to tell engaging stories with characters that audiences can empathize with, much as one would experience in literature or cinema. Real-time digital animation is a critical aspect of creating immersive VR and/or AR experiences. However, the performance constraints of real-time rendering can limit the fidelity of such experiences.

### SUMMARY

Various embodiments of the present technology can include systems, methods, and non-transitory computer readable media configured to perform operations comprising: determining data associated with a mesh of a three-dimensional object; generating a partially subdivided mesh based on the mesh and the data.

In an embodiment, the operations further comprise: causing generation of a tessellation of the partially subdivided mesh.

In an embodiment, generating the partially subdivided mesh comprises: generating subdivided face vertices based on faces of the mesh tagged for subdivision; generating subdivided edge vertices based on edges of the mesh tagged for subdivision and the subdivided face vertices; and generating subdivided vertices based on vertices of the mesh tagged for subdivision, the subdivided edge vertices, and the subdivided face vertices.

In an embodiment, generating the subdivided edge vertices is based on smoothing rules. The smoothing rules are based on at least one of: an edge creasing weight of an edge to be subdivided and a number of incident faces to be subdivided.

In an embodiment, generating the subdivided vertices is based on smoothing rules. The smoothing rules are based on at least one of: a number of incident edges to be subdivided, a number of incident faces to be subdivided, an edge creasing weight of an incident edge to be subdivided, and an average crease weight of incident edges to be subdivided.

In an embodiment, causing generation of the tessellation is based on predefined tessellation rules associated with predefined cases of face configurations.

In an embodiment, causing generation of the tessellation is based on at least one of: a base case of a face that has one or two vertices, a base case of a face that has three face vertices, and a base case of a face that has more than three face vertices and no subdivided edge vertices.

In an embodiment, causing generation of the tessellation comprises: identifying a face vertex for a face to be subdivided that is a subdivided edge vertex for the face; and generating a subdivided face based on the subdivided edge vertex.

In an embodiment, the data associated with the mesh are based on a machine learning model. The machine learning model is trained to determine the data based on parameters associated with faces, edges, and vertices of the mesh.

In an embodiment, the tessellation of the partially subdivided mesh is rendered in real-time.

In an embodiment, the data includes at least one of: a zero level associated with a polygonal face, edge, or vertex, a non-zero integer level associated with a level of subdivision, and a non-zero non-integer level associated with a fractional level of subdivision.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including a partial subdivision module, according to various embodiments of the present technology.

FIG. 2 illustrates an example block diagram related to partial subdivision surfaces, according to various embodiments of the present technology.

FIGS. 3A-3B illustrate examples related to subdivision surfaces, according to various embodiments of the present technology.

FIGS. 4A-4C illustrate examples related to partial subdivision surfaces, according to various embodiments of the present technology.

FIGS. 5A-5B illustrate examples related to tessellation of partially subdivided surfaces, according to various embodiments of the present technology.

FIG. 6 illustrates an example method, according to various embodiments of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Partial Subdivision Surfaces

Virtual reality (VR), augmented reality (AR), mixed reality (MR) (i.e., spatial computing) are new media for entertainment and storytelling that enable content creators to immerse the viewer in ways that are not possible in other media. VR, AR, and MR are powerful immersive platforms to tell engaging stories with characters that audiences can empathize with, much as one would experience in literature or cinema. Real-time digital animation is a critical aspect of creating interactive immersive experiences. However, the performance constraints of real-time rendering can limit the fidelity of such experiences.

Various real-time applications for immersive experiences, such as VR, AR, MR, interactive videos, and video games, can involve computational trade-offs to balance performance, fidelity, and other considerations. For example, a three-dimensional (3D) object, such as a 3D character, can be rendered two frames at a time (one for each eye) within 11 milliseconds for a frame rate of 90 frames per second to produce a visually smooth animation of the 3D object. Increasing the detail of the 3D object, for example by increasing the number of polygons used to outline the surface of the 3D object, can increase the computational cost of rendering the 3D object in real time and reduce the frame rate at which the 3D object can be rendered. Reducing the detail of the 3D object can increase the frame rate at which the 3D object can be rendered but leave the 3D object less visually appealing. Therefore, increasing detail in real-time applications for immersive experiences and interactive video games faces technological problems. Conventional approaches to digital animation are not effective in addressing these and other technological problems.

An improved approach rooted in computer technology overcomes the foregoing and other disadvantages associated with conventional approaches specifically arising in the realm of computer technology. The present technology provides for rendering digital animation based on partially subdivided surfaces, wherein portions of the subdivision surface mesh are subdivided and smoothed while other regions of the mesh are not subdivided and remain polygonal. A partially subdivided surface on a 3D object can be identified by tags (e.g., data). The 3D object can include a mesh of surfaces indicated by faces, edges, and vertices. A portion of the mesh that is to be subdivided can be identified based on tagging of the faces, edges, and vertices associated with the portion of the mesh. Based on the tagged faces, edges, and vertices, subdivision smoothing can be applied to generate a subdivided mesh for the portion of the mesh. The subdivision smoothing can be applied based on, for example, a set of smoothing rules. A partially subdivided mesh can be generated based on the mesh and the subdivided mesh. The subdivided portion of the mesh can correspond with a subdivided portion of the partially subdivided surface of the 3D object. The partially subdivided mesh can be tessellated to generate a tessellation or a triangle mesh. The 3D object can be rendered as part of a digital animation based on the triangle mesh. Rendering digital animation based on partially subdivided surfaces can provide improved efficiency and flexibility in rendering digital animation by applying subdivision smoothing details in specific targeted areas. For example, using partially subdivided surfaces, portions of a 3D character, such as its hands, eyes, and mouth, can be rendered using more polygons than other portions of the 3D character, such as its body. The portions of the 3D character that are more subdivided than the other portions of the 3D character can be rendered with greater detail and with greater capacity for providing subtle deformations (e.g., nuanced character facial performances).

For example, a 3D character can be designed based on a mesh of surfaces. Portions of the mesh corresponding with the mouth, the hands, and the eyebrows of the 3D character can be tagged as portions to be subdivided. Smoothing rules can be applied to the mesh of surfaces to generate subdivided surfaces for the portions of the mesh without subdividing other portions of the mesh. Based on the application of the smoothing rules to the tagged portions of the mesh, a partially subdivided mesh is generated. In this example, the portions of the mesh corresponding with the mouth, the hands, and the eyebrows of the 3D character are subdivided while other portions of the mesh are not subdivided. The partially subdivided mesh can be tessellated into a triangle mesh or a tessellation. The 3D character can be rendered based on the tessellation. As illustrated in this example, the present technology allows for the 3D character, which is rendered based on a partially subdivided mesh of surfaces, to present greater detail provide and be highly deformable at the mouth, the hands, and the eyebrows. This allows the 3D character to express a great range of actions and emotions through its mouth, hands, and eyebrows. Further, because the 3D character is rendered based on a partially subdivided mesh of surfaces, rendering the 3D character is less computationally costly than rendering a 3D character that is rendered based on a fully subdivided mesh of surfaces. While this example illustrates the present technology in the context of rendering a 3D character, the present technology can be applicable to many domains such as entertainment, medical, training, and education contexts. Although many of the features described herein may be described with reference to VR, AR, and MR entertainment, the present technology can be applied to any real-time interactive or simulated environment with a broad range of applications beyond entertainment.

The present technology can be applied to various approaches to subdivision surfaces. One approach to subdivision surfaces is Catmull-Clark subdivision surfaces, which subdivides meshes into quadrilateral structures. Another approach to subdivision surfaces is Loop subdivision surfaces, which subdivides meshes into triangular structures. Other approaches also can be utilized in accordance with the present technology.

The present technology enables a wide variety of individuals, from content creators to artists, to create high-quality character animations with the detail and subtlety that one may expect from a feature film but with the further advantage of running in a real-time application. The present technology removes inefficiencies associated with rendering visually imperceptible or creatively negligible details in a digital animation while emphasizing visually impactful or creatively important details. With the approaches described herein, the present technology overcomes various technological problems related to sub-optimal computational trade-offs that attempt to balance performance, fidelity, and other considerations. More details relating to the present technology are provided below.

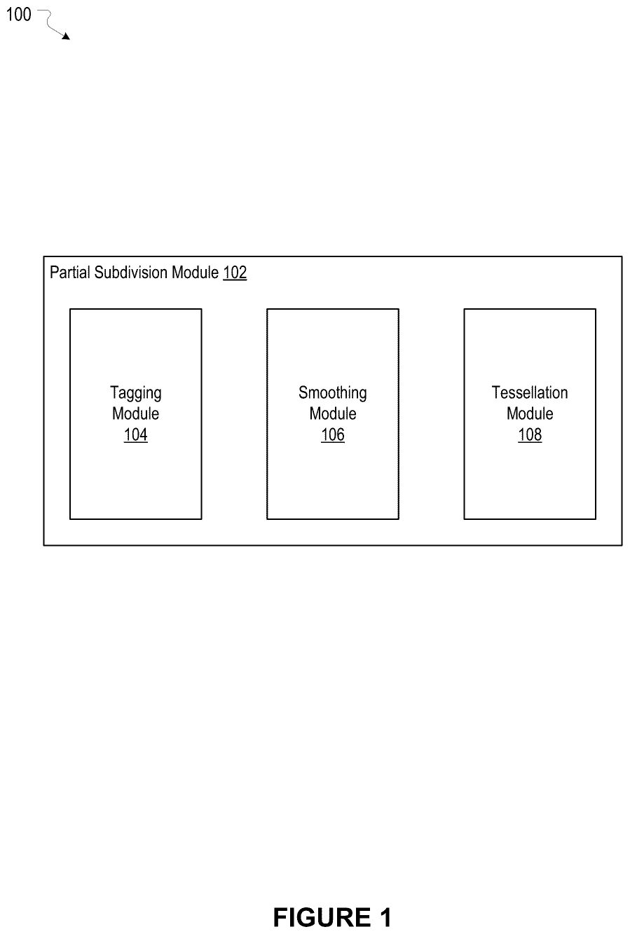

FIG. 1 illustrates an example system 100 including a partial subdivision module 102, according to an embodiment of the present technology. The partial subdivision module 102 can be implemented in one or more software applications running on one or more computing devices. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the partial subdivision module 102 can be implemented in any suitable combinations.

In some embodiments, the various modules and/or applications described herein can be implemented, in part or in whole, as software, hardware, or any combination thereof. In general, a module and/or an application, as discussed herein, can be associated with software, hardware, or any combination thereof. In some implementations, one or more functions, tasks, and/or operations of modules and/or applications can be carried out or performed by software routines, software processes, hardware, and/or any combination thereof. In some instances, the various modules and/or applications described herein can be implemented, in part or in whole, as software running on one or more computing devices or systems, such as on a user or client computing device or on a server. For example, one or more modules and/or applications described herein, or at least a portion thereof, can be implemented as or within an application (e.g., app), a program, or an applet, etc., running on a user computing device or a client computing system. In another example, one or more modules and/or applications, or at least a portion thereof, can be implemented using one or more computing devices or systems that include one or more servers, such as network servers or cloud servers. Many variations are possible.

As illustrated in FIG. 1, the partial subdivision module 102 can include a tagging module 104. The tagging module 104 can facilitate tagging of faces, edges, and vertices of a mesh (e.g., base level mesh, level 0 mesh, control mesh), as described herein. The tagging can indicate the faces, edges, and vertices of the mesh that are to be subdivided. In an example, the faces, edges, and vertices of the mesh that are not tagged indicate that they will not be subdivided (e.g., polygonal). The faces, edges, and vertices of the mesh can also be tagged to indicate a number of subdivisions (e.g., levels of subdivisions) to be applied. In an example, the number of subdivisions is fractional representing a blend between two levels of subdivision. The mesh can be associated with a 3D object. In some instances, faces, edges, and vertices of a mesh can be tagged by a user. For example, a base level mesh can be provided to a user through a modelling tool. The modelling tool can allow the user to tag faces, edges, and vertices of the base level mesh by painting a mask layer on the base level mesh. The user can tag faces, edges, and vertices of the base level mesh to identify which faces, which edges, and which vertices are part of a surface of the base level mesh to be subdivided. The user can tag faces, edges, and vertices of the base level mesh to identify which faces, which edges, and which vertices are part of a surface of the base level mesh that is polygonal or not to be subdivided. A mesh can initially be tagged with default values that a user updates. For example, the mesh can include faces, edges, and vertices initially tagged as polygonal. The user can tag the faces, edges, and vertices as to be subdivided (e.g., for subdivision). The faces, edges, and vertices that the user does not tag can remain tagged as polygonal. In some instances, a portion of a mesh or a submesh can be tagged as polygonal or to be subdivided. Faces, edges, and vertices within the portion of the mesh can be automatically tagged as polygonal or to be subdivided based on a tag of the portion of the mesh. A face of a mesh can be tagged as polygonal or to be subdivided. Edges and vertices within the face can be automatically tagged as polygonal or to be subdivided based on a tag of the face. An edge of a mesh can be tagged as polygonal or to be subdivided. Vertices within the edge can be automatically tagged as polygonal or to be subdivided based on a tag of the edge. In some instances, faces and edges can be automatically tagged based on their vertices. If all vertices of a face are tagged as to be subdivided, then the face can be automatically tagged as to be subdivided. If the face has at least one vertex that is tagged as polygonal, then the face can be automatically tagged as polygonal. If all vertices of an edge are tagged as to be subdivided, then the edge can be automatically tagged as to be subdivided. If the edge has at least one vertex that is tagged as polygonal, then the edge can be automatically tagged as polygonal. In one example, the faces, edges, and vertices can be tagged with an integer value representing the number of levels to subdivide. In this example, a face, edge, or vertex tagged with level 0 would remain polygonal. A tag of level 1 represents doing one subdivision step and then remaining polygonal (e.g., not subdivided) for addition steps. A tag of level 2 translates to doing two subdivision steps and then continuing as polygonal for further steps. The subdivision level tag is similar to subdivision sharp and semi-sharp creases with one exception. Subdivision creases modify the position of subdivided vertices based on creasing data, but they do not affect the subdivision topology, whereas the subdivision level tag affects both the positions of the subdivided vertices and the resulting subdivided topology. In another embodiment, the faces, edges, and vertices can be tagged with a floating point (e.g., non-integer) value representing a fractional number of levels to be subdivided, corresponding to a blend between two levels of subdivision. As an example, a tag of level 0.5 represents a blend between zero subdivision steps (e.g., polygonal) and one subdivision step. In this example, the subdivision level tag is analogous to the subdivision semi-sharp creases except that it modifies both the positions of the subdivided vertices and the topology. These tags for faces, edges, and vertices can be stored as metadata associated with the faces, edges, and vertices of the base level mesh. In additional instances, the metadata can include information related to creases (e.g., sharp creases, semi-sharp creases, crease values), weights (e.g., stencil weights), importance (e.g., main character, side character, object of interest, background object), identifications (e.g., moving body part, inanimate object) associated with the base level mesh. For example, edges can be tagged as crease edges with an associated floating point sharpness value. The metadata can be used as inputs for subdivision of the surfaces of the mesh.

For example, a user can tag a mesh of surfaces corresponding to a 3D character in a modelling tool. In this example, the user can identify portions of the mesh corresponding to hands of the 3D character as surfaces of the mesh to be subdivided. Based on the user identification of the portions of the mesh, faces, edges, and vertices within the portions of the mesh can be tagged with metadata indicating that these faces, edges, and vertices are to be subdivided. Further, the user can tag individual vertices within the mesh as part of surfaces of the mesh to be subdivided. Based on the individual vertices the user tagged as to be subdivided, edges of which all vertices are tagged as to be subdivided can be automatically tagged as to be subdivided. Likewise, faces of which all vertices are tagged as to be subdivided can be automatically tagged as to be subdivided. Other faces, edges, and vertices of the mesh that the user did not tag can be tagged as polygonal by default. Many variations are possible.

In some instances, the tagging module 104 can automatically tag faces, edges, and vertices of a mesh of a 3D object based on an algorithm. A determination can be made of which of the faces, edges, and vertices of the mesh are to be tagged as to be subdivided based on parameters associated with the faces, edges, and vertices. The parameters can relate to how the 3D object is to be displayed, such as an amount of screen space occupied by the 3D object, polygon size associated with the 3D object, a distance between the 3D object and a viewer, whether the 3D object is in a foreground, and whether the 3D object is in a background. The parameters can relate to technical capabilities of a device for display of the 3D object, such as a rendering budget (e.g., number of polygons that can be rendered per frame) and a frame rate. The parameters can relate to contextual information related to the 3D object, such as an importance of the 3D object and important features of the 3D object (e.g., hands, eyes, highly deformable parts of the 3D object). The parameters, such as the contextual information related to the 3D object, can be based on metadata associated with the faces, edges, and vertices of the mesh. Based on the parameters, the faces, edges, and vertices of the mesh can be ranked. The faces, edges, and vertices can be tagged based on the ranking. Faces, edges, and vertices of the mesh that are ranked higher than other faces, edges, and vertices of the mesh can be tagged as to be subdivided. Faces, edges, and vertices of the mesh that are ranked lower than other faces, edges, and vertices of the mesh can be tagged as polygonal or not to be subdivided.

For example, an application on a device can render a digital animation that includes a first 3D object and a second 3D object. First faces, edges, and vertices of a first mesh of the first 3D object and second faces, edges, and vertices of a second mesh of the second 3D object can be automatically tagged as to be subdivided or polygonal based on first parameters associated with the first faces, edges, and vertices and second parameters associated with the second faces, edges, and vertices. In this example, the first 3D object can be a main character of the digital animation and include highly deformable appendages that are identified as important features of the first 3D object. The second 3D object can be a background object placed further from a viewer of the digital animation than the first 3D object. The device can be associated with a render budget that indicates a number of polygons the device can render per frame at, for example, 30 frames per second. Based on the first parameters, the second parameters, and the render budget, the first faces, edges, and vertices and the second faces, edges, and vertices can be ranked. In this example, the first faces, edges, and vertices that correspond with the highly deformable appendages of the first 3D object can be ranked higher than the first faces, edges, and vertices that correspond with other portions of the first 3D object. The first faces, edges, and vertices that correspond with the other portions of the first 3D object can be ranked higher than the second faces, edges, and vertices of the second 3D object. Based on the ranking and the render budget, the first faces, edges, and vertices that correspond with the highly deformable appendages of the first 3D object can be automatically tagged as to be subdivided. The first faces, edges, and vertices that correspond with the other portions of the first 3D object and the second faces, edges, and vertices of the second 3D object can be automatically tagged as polygonal. Many variations are possible.

In some instances, the tagging module 104 can automatically tag faces, edges, and vertices of a mesh of a 3D object based on machine learning methodologies (e.g., artificial intelligence or AI). For example, a machine learning model can be trained to tag faces, edges, and vertices of a mesh as to be subdivided or polygonal. The machine learning model can be trained based on a set of animation training data that includes animated base level control meshes as well as the associated fully subdivided meshes, and parameters associated with the faces, edges, and vertices of the base level meshes. The machine learning model can be trained to tag the faces, edges, and vertices of the base level meshes to generate the partially subdivided meshes based on an optimization function that minimizes the error between the fully subdivided meshes and partial subdivision meshes. The optimization function can find a solution that tags regions with high model detail and broad range of animation deformations. In one embodiment, the animation training data is associated with the singular 3D object or character. In another embodiment, the animation training data is associated with a variety of 3D objects or characters that are similar types (e.g., humans or quadrupeds). In other variations, the optimization function can find solutions based on the set of parameters associated with the faces, edges, and vertices of the base level meshes. The trained machine learning model can be applied to a control mesh of a 3D object and, based on parameters associated with faces, edges, and vertices of the mesh, identify the faces, edges, and vertices of the mesh that are to be tagged as to be subdivided or to be tagged as polygonal. The faces, edges, and vertices of the mesh can be tagged based on the trained machine learning model. Many variations are possible.

For example, an application on a device can render a digital animation that includes a 3D character. Faces, edges, and vertices of a mesh of the 3D character can be automatically tagged for subdivision or polygonal based on a machine learning model. The machine learning model can identify the faces, edges, and vertices of the mesh that are to be tagged for subdivision based on parameters associated with the faces, edges, and vertices. In this example, the parameters associated with the faces, edges, and vertices of the mesh can indicate that hands, eyes, and a mouth of the 3D character are important features of the 3D character. The machine learning model can, based on the parameters, identify the faces, edges, and vertices associated with the hands, the eyes, and the mouth of the 3D character as to be tagged for subdivision. The faces, edges, and vertices associated with the hands, the eyes, and the mouth of the 3D character can be tagged for subdivision based on the machine learning model. Many variations are possible.

In some instances, the tagging module 104 can automatically tag in real-time (or near real-time) faces, edges, and vertices based on an algorithmic technique, a machine learning model, or a combination of both. For example, meshes in a frame of digital animation can be automatically tagged in real-time and subdivided prior to rendering the frame. The meshes in each frame of the digital animation can be automatically tagged and subdivided in this way. In some instances, meshes in a selected set of frames or a block of digital animation can be automatically tagged in a uniform manner in real-time so that partial subdivision of the meshes are consistent (e.g., temporally cohesive) through the set of frames or the block of digital animation.

As illustrated in FIG. 1, the partial subdivision module 102 can include a smoothing module 106. The smoothing module 106 can generate a partially subdivided mesh based on faces, edges, and vertices of a mesh (e.g., base level mesh, level 0 mesh, control mesh). Generation of the partially subdivided mesh can include generation of subdivided faces, edges, and vertices based on the faces, edges, and vertices of the mesh. The subdivided faces, edges, and vertices can be generated based on application of smoothing rules to the faces, edges, and vertices of the mesh. The application of the smoothing rules to the faces, edges, and vertices of the mesh can be based on metadata, including tags, associated with the faces, edges, and vertices of the mesh.

As a general overview of applying smoothing rules to generate partially subdivided meshes, a partially subdivided mesh can be generated from a mesh by iterating through faces, edges, and vertices of the mesh to generate subdivided faces, edges, and vertices for a subdivided portion of the partially subdivided mesh. Iterating through the faces, edges, and vertices of the mesh can begin with iterating through the faces first, iterating through the edges second, and iterating through the vertices third. For a face that is tagged as to be subdivided (e.g., tagged for subdivision), a subdivided face point, or subdivided face vertex, is determined based on face points, or face vertices, associated with the face. The subdivided face point can be based on a weighted centroid (e.g., center point) of the face determined based on the face points (e.g., stencil points) of the face and weights (e.g., stencil weights) associated with the face points. For a face that is tagged as polygonal, the face is skipped (e.g., no subdivided face point is determined). For an edge that is tagged as to be subdivided, a subdivided edge point, or subdivided edge vertex, is determined based on edge points, or edge vertices, associated with the edge and face points, or face vertices, associated with incident faces. The subdivided edge point can be based on a weighted centroid (e.g., center point) of the edge determined based on the edge points of the edge and the subdivided face points of the incident faces (e.g., stencil points), weights (e.g., stencil weights) associated with the edge points and the subdivided face points, and a crease value associated with the edge (e.g., edge crease weight, edge crease sharpness value). For an edge that is tagged as polygonal, the edge is skipped (e.g., no subdivided edge point is determined). For a vertex that is tagged as to be subdivided, a subdivided vertex, or subdivided vertex point, can be determined based on the vertex and associated faces and edges. The subdivided vertex point can be based on the subdivided face points (e.g., stencil points) of the incident faces tagged as to be subdivided, edge points (e.g., stencil points) of the edges tagged as to be subdivided, and vertex point (e.g., stencil points), and weights (e.g., stencil weights) associated with the subdivided face points, the edge points, and vertex point. For a vertex that is tagged as polygonal, the vertex is skipped (e.g., no subdivided vertex is determined). The partial subdivision smoothing rules can be applied repeatedly, producing further levels of refinement. In some instances, faces, edges, and vertices can be tagged with a specific level of subdivision refinement. Faces, edges, and vertices tagged with zero levels of refinement are equivalent to being tagged as polygonal. Faces, edges, and vertices that tagged with one or more levels of refinement are equivalent to being tagged as subdivided. Faces, edges, and vertices tagged with levels of refinement between zero and one are treated as a linear interpolation or blend between polygonal and subdivided. To compute the next level of subdivision smoothing, all levels of subdivision tags are reduced by one, all levels of edge creasing tags are reduced by one, and the process is repeated. Any updated level of subdivision tag below zero is set to zero (i.e., tagged as polygonal) and any updated level of edge creasing tags below zero is set to zero.

In an example of applying smoothing rules to generate subdivided face points, a face can be described by face vertices or face points [v₁, v₂, . . . , vₙ] where vₙ is the nth face vertex (e.g., stencil points). The face vertices can be associated with weights 1/n where n is the number of face vertices (e.g., stencil weights). As pseudocode, this example can be provided as:

```
Stencil Points and Weights
  Weights: [1/n, 1/n, ..., 1/n]
    where n is the number of face vertices.
  Points: [v₁, v₂, ..., vₙ]
    where v₁ is the first face vertex.
    where v₂ is the second face vertex.
    where vₙ is the nth face vertex.
```

The subdivided face point can be generated based on the stencil points (e.g., face vertices) and the stencil weights. For example, the subdivided face point can be generated based on a weighted combination or dot product (herein referred to as weighted combination) determined based on the stencil points and the stencil weights (e.g., v₁/n+v₂/n+ . . . . vₙ/n).

In an example of applying smoothing rules to generate subdivided edge points, an edge can be described by a pair of edge points, or edge vertices [e₁, e₂]. Different smoothing rules can be applied based on whether the edge has no edge creasing (e.g., edge creasing weight=0), whether the edge has sharp edge creasing (e.g., edge creasing weight ≥1), and whether the edge has semi-sharp edge creasing (e.g., edge creasing weight <1), as well as based on whether the edge has incident faces that are subdivided and whether the edge has incident faces with blended or fractional levels of subdivisions between 0 and 1 (e.g., a blend between polygonal and subdivided).

For an example of an edge that has no edge creasing and has two incident subdivided faces (e.g., is between two subdivided faces), a subdivided edge point can be generated based on edge points, or edge vertices, of the edge and subdivided face points, or subdivided face vertices, of the two incident subdivided faces (e.g., stencil points). The edge points and the subdivided face points can have associated weights (e.g., stencil weights) based on the number of vertices (e.g., ¼). As pseudocode, this example can be provided as:

```
Applied when:
  two incident subdivided faces; and
  no edge creasing.
Stencil Points and Weights
  Weights: [¼, ¼, ¼, ¼].
  Points: [e₁, e₂, f₁, f₂] where
    e₁ is the first edge vertex;
    e₂ is the second edge vertex;
    f₁ is the first incident subdivided face vertex;
    f₂ is the second incident subdivided face vertex.
```

The subdivided edge point can be generated based on the stencil points (e.g., edge vertices subdivided face vertices) and the stencil weights. For example, the subdivided edge point can be generated based on a weighted combination determined based on the stencil points and the stencil weights (e.g., e₁/4+e₂/4+f₁/4+f₂/4).

For an example of an edge that has sharp edge creasing, has one incident subdivided face (e.g., on a border), or has one incident subdivided face and one incident polygonal face (e.g., is between a subdivided face and a polygonal face), a subdivided edge point can be generated based on edge points or edge vertices of the edge (e.g., stencil points). The edge points or edge vertices can have associated weights (e.g., stencil weights) based on the number of points or vertices (e.g., ½). As pseudocode, this example can be provided as:

```
Applied when:
  edge creasing weight ≥ 1; or
  border edge (one incident subdivided face); or
  either incident face is not subdivided.
Stencil Points and Weights
  Weights: [½, ½].
  Points: [e₁, e₂] where
    e₁ is the first edge vertex;
    e₂ is the second edge vertex.
```

The subdivided edge point can be generated based on the stencil points (e.g., edge vertices) and the stencil weights. For example, the subdivided edge point can be generated based on a weighted combination determined based on the stencil points and the stencil weights (e.g., e₁/2+e₂/2).

For an example of an edge that has semi-sharp edge creasing and has two incident subdivided faces (e.g., is between two subdivided faces), a subdivided edge point can be generated based on edge points, or edge vertices, of the edge and subdivided face points, or subdivided face vertices, of the two incident subdivided faces (e.g., stencil points). The edge points and the subdivided face points can have associated weights (e.g., stencil weights) based on a linear interpolation function applied to an edge crease weight (e.g., edge crease sharpness value) of the edge. As pseudocode, this example can be provided as:

```
Applied when
  two incident subdivided faces; and
  edge creasing weight < 1.
Stencil Points and Weights
  Weights: [lerp(¼,½, e_{w}), lerp(¼,½,e_{w}), lerp(½,0,e_{w}),
  lerp(½,0,e_{w})] where
    lerp is a linear interpolation function;
    e_{w} is the edge crease weight.
  Points: [e₁, e₂, f₁, f₂] where
    e₁ is the first edge vertex;
    e₂ is the second edge vertex;
    f₁ is the first incident face subdivided vertex;
    f₂ is the second incident face subdivided vertex.
```

The subdivided edge point can be generated based on the stencil points (e.g., edge vertices, subdivided face vertices) and the stencil weights. For example, the subdivided edge point can be generated based on a weighted combination determined based on the stencil points and the stencil weights (e.g., e₁/lerp(¼,½, e_{w})+e₂/lerp(¼,½,e_{w})+f₁/lerp(½,0,e_{w})+f₂/lerp(½,0,e_{w})).

For an example of an edge that has at least one face with blended or fractional levels of subdivisions between 0 and 1 (e.g., a blend between polygonal and subdivided for each face), a subdivided edge point can be generated based on edge points, or edge vertices, of the edge and subdivided face points, or subdivided face vertices, of the two incident subdivided faces (e.g., stencil points). The edge points and the subdivided face points can have associated weights (e.g., stencil weights) based on a linear interpolation function applied to an edge crease weight (e.g., edge crease sharpness value) of the edge and based on an averaging function based on the fractional levels of subdivisions for the incident faces (e.g., a blend between polygonal and subdivided). As pseudocode, this example can be provided as:

```
Applied when
  two incident faces; and
  subdivision level for either incident face is between 0 and 1.
Stencil Points and Weights
  Weights: [lerp(¼,½, 1−average(l₁, l₂)), lerp(¼,½, 1−average(l₁, l₂)),
lerp(½,0, 1−l₁), lerp(½,0, 1−l₂)] where
    lerp is a linear interpolation function;
    average is an averaging function;
    l₁ is the fractional subdivision level for the 1^{st} incident face;
    l₂ is the fractional subdivision level for the 2^{nd} incident face.
  Points: [e₁, e₂, f₁, f₂] where
    e₁ is the first edge vertex;
    e₂ is the second edge vertex;
    f₁ is the first incident face subdivided vertex;
    f₂ is the second incident face subdivided vertex.
```

The subdivided edge point can be generated based on the stencil points (e.g., edge vertices, subdivided face vertices,) and the stencil weights. For example, the subdivided edge point can be generated based on a weighted combination determined based on the stencil points and the stencil weights (e.g., e₁/lerp(¼,½, 1−average (l₁, l₂))+e₂/lerp(¼,½, 1−average (l₁, l₂))+f₁/lerp(½,0, 1−l₁)+f₂/lerp(½,0, 1−l₂)).

For an example of an edge that has semi-sharp edge creasing and at least one face with blended or fractional levels of subdivisions between 0 and 1 (e.g., a blend between polygonal and subdivided for the face or faces), a subdivided edge point can be generated based on edge points, or edge vertices, of the edge and subdivided face points, or subdivided face vertices, of the two incident subdivided faces (e.g., stencil points). The edge points and the subdivided face points can have associated weights (e.g., stencil weights) based on a linear interpolation function applied to an edge crease weight (e.g., edge crease sharpness value) of the edge and based on an averaging function based on the fractional levels of subdivisions for the incident faces (e.g., a blend between polygonal and subdivided). As pseudocode, this example can be provided as:

```
Applied when
  two incident faces;
  edge creasing weight < 1; and
  subdivision level for either incident face is between 0 and 1.
Stencil Points and Weights
  Weights: [lerp(¼,½, average((1−l₁)*e_{w}, (1−l₂)*e_{w})), lerp(¼,½,
average(1−l₁)* e_{w}, (1−l₂)*e_{w})), lerp(½,0, (1−l₁)*e_{w}), lerp(½,0,
(1−l₂)*e_{w})] where
    lerp is a linear interpolation function;
    average is an averaging function;
    e_{w} is the edge crease weight;
    l₁ is the fractional subdivision level for the 1^{st} incident face;
    l₂ is the fractional subdivision level for the 2^{nd} incident face.
  Points: [e₁, e₂, f₁, f₂] where
    e₁ is the first edge vertex;
    e₂ is the second edge vertex;
    f₁ is the first incident face subdivided vertex;
    f₂ is the second incident face subdivided vertex.
```

The subdivided edge point can be generated based on the stencil points (e.g., edge vertices, subdivided face vertices) and the stencil weights. For example, the subdivided edge point can be generated based on a weighted combination determined based on the stencil points and the stencil weights (e.g., e₁/lerp(¼,1/2, average ((1−l₁)*e_{w}, (1−l₂)*e_{w}))+e₂/(¼,1/2, average ((1−l₁)*e_{w}, (1−l₂)*e_{w}))+f₁/lerp(½,0, (1−l₁)*e_{w})+f₂/lerp(½,0, (1−l₂)*e_{w}).

In an example of applying smoothing rules to generate subdivided vertices, a vertex (v) or vertex point can be a point in a mesh at a level of subdivision (e.g., level 0, level 1). A subdivided vertex point can be generated based on incident subdivided faces, incident subdivided edges, and the vertex. Incident polygonal faces and incident polygonal edges can be removed or excluded from the determination of the subdivided vertex. Only incident faces and incident edges that are going to subdivided are considered in applying vertex smoothing rules. Different smoothing rules can be applied based on various factors, such as a number of incident subdivided edges that have creases (n_{c}), a number of incident subdivided edges (nₑ), a number of incident subdivided faces (n_{f}), a number of incident blended or fractional and fully subdivided edges (nₗ), an average level weight for all blended or fractional and fully subdivided edges (vₗ), and an average crease weight for all incident subdivided edges that have creases (v_{w}). For example, different smoothing rules can be applied based on whether the vertex is on a corner (e.g., one incident subdivided face and two incident subdivided edges), whether the vertex is on a border (e.g., two incident subdivided faces and three incident subdivided edges), whether the vertex has multiple incident subdivided faces (e.g., at least three incident subdivided edges), whether the vertex is on a sharp crease (e.g., two incident subdivided edges have creases and average crease weight ≥1), whether the vertex is on a semi-sharp crease (e.g., two incident subdivided edges have creases and average crease weight <1), and whether incident edges have blended or fractional levels of subdivisions between 0 and 1 (e.g., a blend between polygonal and subdivided).

For an example of a vertex on a corner, a subdivided vertex point can be generated based on the vertex or be generated at the same point as the vertex. As pseudocode, this example can be provided as:

```
Applied when:
  one incident subdivided face and two incident subdivided edges (n_{f} = 1
and nₑ = 2); or
  at least three incident subdivided edges that have creases (n_{c} ≥ 3).
Stencil Points and Weights
  Weights: [1].
  Points: [v]
    where v is the vertex.
```

The subdivided vertex point can be generated based on the vertex. For example, the subdivided vertex point can be generated at the same point as the vertex.

For an example of a vertex that is on a border, a subdivided vertex can be generated based on the vertex and incident vertices or vertices on the border (e.g., stencil points). The vertex and incident vertices can have associated weights (e.g., stencil weights). As pseudocode, this example can be provided as:

```
Applied when:
  two incident subdivided faces and three incident subdivided edges
(n_{f} = 2 and nₑ = 3).
Stencil Points and Weights
  Weights: [¾, ⅛, ⅛].
  Points: [v, v₁, v₂] where
    v is the vertex;
    v₁ is the first incident vertex;
    v₂ is the second incident vertex.
```

The subdivided vertex point can be generated based on the stencil points (e.g., vertex, incident vertices) and the stencil weights. For example, the subdivided vertex point can be generated based on a weighted combination determined based on the stencil points and the stencil weights (e.g., ¾v+⅛v₁+⅛v₂).

For an example of a vertex that has multiple incident subdivided faces, a subdivided vertex can be generated based on the vertex, edge vertices or edge points of incident subdivided edges and subdivided face points of incident subdivided faces (e.g., stencil points). The vertex, the edge vertices, and the subdivided face vertices can have associated weights (e.g., stencil weights) based on a total number of the vertex, the edge vertices, and the face vertices. As pseudocode, this example can be provided as:

```
Applied when:
  Number of incident edges is at least three (nₑ ≥ 3);
Stencil Points and Weights
  Weights:
    [1/n²,1/n², ..., 1/n²] for subdivided face point of incident subdivided
faces;
    [1/n²,1/n², ..., 1/n²] for edge vertices of incident subdivided edges;
    [n−2/n] for the vertex where
      n is the number of subdivided face point of incident
subdivided faces, edge vertices of incident subdivided edges, and the
vertex.
  Points:
    [f₁, f₂, ..., fᵢ] where
      f₁ is the first subdivided face point of incident subdivided
faces;
      f₂ is the second subdivided face point of incident subdivided
faces;
      fᵢ is the ith subdivided face point of incident subdivided faces;
    [e₁, e₂, ..., eₓ] where
      e₁ is the first edge vertex of incident subdivided edges;
      e₂ is the second edge vertex of incident subdivided edges;
      eₓ is the xth edge vertex of incident subdivided edges;
    [v] where
      v is the vertex.
```

The subdivided vertex point can be generated based on the stencil points (e.g., subdivided face points of incident subdivided faces, edge vertices of incident subdivided edges, vertex) and the stencil weights. For example, the subdivided vertex point can be generated based on a weighted combination determined based on the stencil points and the stencil weights (e.g., (1/n²)*f₁+ (1/n²)*f₂+ . . . (1/n²)*fᵢ+(1/n²)*e₁+*e₂+ . . . (1/n²)*eₓ+(n−2/n)*v).

For an example of a vertex that is on a sharp crease, a subdivided vertex point can be generated based on the vertex and edge vertices or edge points of adjacent creased edges (e.g., stencil points). The vertex and the edge vertices can have associated weights (e.g., stencil weights). As pseudocode, this example can be provided as:

```
Applied when:
  at least two incident subdivided edges and average crease weight of at
least one (n_{c} > 2 and v_{w} ≥ 1).
Stencil Points and Weights
  Weights: [¾, 1/(4* n_{c}), 1/(4* n_{c}),..., 1/(4* n_{c})].
  Points: [v, e₁, e₂] where
    v is the vertex;
    e₁ is the first adjacent creased edge vertex;
    e₂ is the second adjacent creased edge vertex;
    eᵢ is the ith adjacent creased edge vertex.
```

The subdivided vertex point can be generated based on the stencil points (e.g., vertex, adjacent creased edge vertices) and the stencil weights. For example, the subdivided vertex can be generated based on a weighted combination determined based on the stencil points and the stencil weights (e.g., ¾v+1/(4*n_{c})*e₁+1/(4*n_{c})*e₂+ . . . +1/(4*n_{c})*eᵢ).

For an example of a vertex that is on a semi-sharp crease, a subdivided vertex point can be generated based on the vertex, edge vertices or edge points of incident subdivided edges that are creased, edge vertices or edge points of incident subdivided edges that are not creased, and subdivided face points of incident subdivided faces (e.g., stencil points). The vertex, the edge vertices of incident subdivided edges that are creased, the edge vertices of incident subdivided edges that are not creased, and the subdivided face points of incident subdivided faces can have associated weights (e.g., stencil weights) based on a linear interpolation function (e.g. lerp) and an average crease weight. As pseudocode, this example can be provided as:

```
Applied when:
  at least two incident subdivided edges and average crease weight less
than one (n_{c} ≥ 2 and v_{w} < 1).
Stencil Points and Weights
  Weights:
    [lerp(1/n², 0, v_{w}), lerp(1/n², 0, v_{w}), ..., lerp(1/n²,0,v_{w})] for
subdivided face points of incident subdivided faces;
    [lerp(1/n², 0, v_{w}), lerp(1/n², 0, v_{w}), ..., lerp(1/n², 0, v_{w})] for edge
vertices of incident subdivided edges that are not creased;
    [lerp(1/n², 1/(4* n_{c}), v_{w}), lerp(1/n², 1/(4* n_{c}), v_{w}), ..., lerp(1/n², 1/(4*
n_{c}), v_{w})] for edge vertices of incident subdivided edges that are creased;
    [lerp(n−2/n, ¾, v_{w}] for the vertex where
      lerp is a linear interpolation function;
      n is the number of subdivided face points of incident
subdivided faces, edge vertices of incident subdivided edges that are not
creased, edge vertices of incident subdivided edges that are creased, and
the vertex;
      v_{w} is the average crease weight.
  Points:
    [f₁, f₂, ..., fᵢ] where
      f₁ is the first subdivided face point of incident subdivided
faces;
      f₂ is the second subdivided face point of incident subdivided
faces;
      fᵢ is the ith subdivided face point of incident face subdivided
faces;
    [e₁, e₂, ..., eₓ] where
      e₁ is the first edge vertex of incident subdivided edges that
are not creased;
      e₂ is the second edge vertex of incident subdivided edges
that are not creased;
      eₓ is the xth edge vertex of incident subdivided edges that
are not creased;
    [g₁, g₂, ..., g_{y}] where
      g₁ is the first edge vertex of incident subdivided edges that
are creased;
      g₂ is the second edge vertex of incident subdivided edges
that are creased;
      g_{y} is the yth edge vertex of incident subdivided edges that
are creased;
    [v] where
      v is the vertex.
```

The subdivided vertex point can be generated based on the stencil points (e.g., subdivided face point of incident subdivided faces, edge vertices of incident subdivided edges that are not creased, edge vertices of incident subdivided edges that are creased, vertex) and the stencil weights. For example, the subdivided vertex point can be generated based on a weighted combination determined based on the stencil points and the stencil weights (e.g., lerp(1/n², 0, v_{w})*f₁+lerp(1/n², 0, v_{w})*f₂+ . . . lerp(1/n²,0,v_{w})*fᵢ+lerp(1/n², 0, v_{w})*e₁+lerp(1/n², 0, v_{w})*e₂+ . . . lerp(1/n², 0, v_{w})*eₓ+lerp(1/n², 1/(4*n_{c}), v_{w})*g₁+lerp(1/n², 1/(4*n_{c}), v_{w})*g₂+ . . . lerp(1/n², 1/(4*n_{c}), v_{w})*g_{y}+lerp(n−2/n, ¾, v_{w})*v).

For an example of a vertex that has at least two edges with blended or fractional levels of subdivisions between 0 and 1 (e.g., a blend between polygonal and subdivided for each edge), a subdivided vertex point can be generated based on the vertex, edge vertices or edge points of incident edges that are either fractional or fully subdivided, and subdivided face points of incident subdivided faces (e.g., stencil points). The vertex, the edge vertices of incident subdivided edges that are either fractional or fully subdivided, and the subdivided face points of incident subdivided faces can have associated weights (e.g., stencil weights) based on a linear interpolation function (e.g. lerp), an average level weight for fractional subdivision, and an average crease weight. As pseudocode, this example can be provided as:

```
Applied when:
  at least two incident subdivided edges with a blended or fractional level
of subdivision and with an average level weight less than one (nₗ ≥ 2 and
vₗ < 1).
Stencil Points and Weights
  Weights:
    [lerp(1/n², 0, v_{w}), lerp(1/n², 0, 1−vₗ), ..., lerp(1/n²,0,1−vₗ)] for
subdivided face points of incident subdivided faces;
    [lerp(1/n², 1/(4* nₗ), 1−vₗ), lerp(1/n², 1/(4* nₗ), 1−vₗ), ..., lerp(1/n²,
1/(4* nₗ), 1−vₗ)] for edge vertices of incident subdivided edges that are
either fractional or fully subdivided;
    [lerp(n−2/n, ¾, 1−vₗ] for the vertex where
      lerp is a linear interpolation function;
      n is the number of subdivided face points of incident
subdivided faces, edge vertices of incident subdivided edges that are either
fractional or fully subdivided, and the vertex;
      vₗ is the average level weight for fractional and fully
subdivided edges.
  Points:
    [f₁, f₂, ..., fᵢ] where
      f₁ is the first subdivided face point of incident subdivided
faces;
      f₂ is the second subdivided face point of incident subdivided
faces;
      fᵢ is the ith subdivided face point of incident face subdivided
faces;
    [e₁, e₂, ..., eₓ] where
      e₁ is the first edge vertex of incident subdivided edges that
are fractional or fully subdivided;
      e₂ is the second edge vertex of incident subdivided edges
that are fractional or fully subdivided;
      eₓ is the xth edge vertex of incident subdivided edges that
are fractional or fully subdivided;
    [v] where
      v is the vertex.
```

The subdivided vertex point can be generated based on the stencil points (e.g., subdivided face point of incident subdivided faces, edge vertices of incident subdivided edges that are fractional or fully subdivided, vertex) and the stencil weights. For example, the subdivided vertex point can be generated based on a weighted combination determined based on the stencil points and the stencil weights (e.g., lerp(1/n², 0, 1−vₗ)*f₁+lerp(1/n², 0, 1−v)*f₂+ . . . lerp(1/n²,0,1−vₗ)*fᵢ+lerp(1/n², 1/(4*n), 1−vₗ)*e₁+lerp(1/n², 1/(4*nₗ), 1−v_{w})*e₂+ . . . lerp(1/n², 1/(4*nₗ), 1−vₗ)*eₓ+lerp(n−2/n, ¾, 1−vₗ)*v).

For an example of a vertex that has at least two edges with blended or fractional levels of subdivisions between 0 and 1 (e.g., a blend between polygonal and subdivided for each edge) and that is on a semi-sharp crease, a subdivided vertex point can be generated based on the vertex, edge vertices or edge points of incident subdivided edges that are creased, edge vertices or edge points of incident subdivided edges that are not creased, and subdivided face points of incident subdivided faces (e.g., stencil points). The vertex, the edge vertices of incident subdivided edges that are creased, the edge vertices of incident subdivided edges that are not creased, and the subdivided face points of incident subdivided faces can have associated weights (e.g., stencil weights) based on a linear interpolation function (e.g., lerp) and an average crease weight. As pseudocode, this example can be provided as:

```
Applied when:
  at least two incident subdivided edges with a blended or fractional level
of subdivision (nₗ ≥ 2 and vₗ < 1); and
  at least two incident subdivided edges and average crease weight less
than one (n_{c} ≥ 2 and v_{w} < 1).
Stencil Points and Weights
  Weights:
    [lerp(1/n², 0, (1−vₗ)*v_{w}), lerp(1/n², 0, (1−vₗ)*v_{w}), ..., lerp(1/n²,0, (1−
vₗ)*v_{w})] for subdivided face points of incident subdivided faces;
    [lerp(1/n², 0, (1−vₗ)*v_{w}), lerp(1/n², 0, (1−vₗ)*v_{w}), ..., lerp(1/n², 0, (1−
vₗ)*v_{w})] for edge vertices of incident subdivided edges that are not
creased;
    [lerp(1/n², 1/(4* n_{c}), (1−vₗ)*v_{w}), lerp(1/n², 1/(4* n_{c}), (1−vₗ)*v_{w}), ...,
lerp(1/n², 1/(4* n_{c}), (1−vₗ)*v_{w})] for edge vertices of incident subdivided
edges that are creased;
    [lerp(n−2/n, ¾, (1−vₗ)*v_{w}] for the vertex where
      lerp is a linear interpolation function;
      n is the number of subdivided face points of incident
subdivided faces, edge vertices of incident subdivided edges that are not
creased, edge vertices of incident subdivided edges that are creased, and
the vertex;
      v_{w} is the average crease weight; and
      vᵢ is the average level weight for partial and fully subdivided
edges.
  Points:
    [f₁, f₂, ..., fᵢ] where
      f₁ is the first subdivided face point of incident subdivided
faces;
      f₂ is the second subdivided face point of incident subdivided
faces;
      fᵢ is the ith subdivided face point of incident face subdivided
faces;
    [e₁, e₂, ..., eₓ] where
      e₁ is the first edge vertex of incident subdivided edges that
are not creased;
      e₂ is the second edge vertex of incident subdivided edges
that are not creased;
      eₓ is the xth edge vertex of incident subdivided edges that
are not creased;
    [g₁, g₂, ..., g_{y}] where
      g₁ is the first edge vertex of incident subdivided edges that
are creased;
      g₂ is the second edge vertex of incident subdivided edges
that are creased;
      g_{y} is the yth edge vertex of incident subdivided edges that
are creased;
    [v] where
      v is the vertex.
```

The subdivided vertex point can be generated based on the stencil points (e.g., subdivided face point of incident subdivided faces, edge vertices of incident subdivided edges that are not creased, edge vertices of incident subdivided edges that are creased, vertex) and the stencil weights. For example, the subdivided vertex point can be generated based on a weighted combination determined based on the stencil points and the stencil weights (e.g., lerp(1/n², 0, (1−vₗ)*v_{w})*f₁+lerp(1/n², 0, (1−vₗ)*v_{w})*f₂+ . . . lerp(1/n²,0, (1−vₗ)*v_{w})*fᵢ+lerp(1/n², 0, (1−v)*v_{w})*e₁+lerp(1/n², 0, (1−vₗ)*v_{w})*e₂+ . . . lerp(1/n², 0, (1−vₗ)*v_{w})*eₓ+lerp(1/n², 1/(4*n_{c}), (1−vₗ)*v_{w})*g₁+lerp(1/n², 1/(4*n_{c}), (1−vₗ)*v_{w})*g₂+ . . . lerp(1/n², 1/(4*n_{c}), (1−vₗ)*v_{w})*g_{y}+lerp(n−2/n, ¾, (1−vₗ)*v_{w})*v).

For example, a mesh of surfaces for a 3D object can be partially subdivided based on tags associated with faces, edges, and vertices of the mesh. The tags can identify which of the faces, edges, and vertices of the mesh are to be subdivided and which are polygonal. A partially subdivided mesh can be generated based on the mesh. In this example, the partially subdivided mesh can be generated by first iterating through the faces of the mesh that are tagged as to be subdivided. For the faces tagged as to be subdivided, subdivided face points can be generated using stencil points and stencil weights based on face vertices of the faces tagged as to be subdivided. Next, the partially subdivided mesh can be generated by iterating through the edges of the mesh that are tagged as to be subdivided. For the edges tagged as to be subdivided, subdivided edge points can be generated using stencil points and stencil weights based on edge vertices of the edges tagged as to be subdivided and the subdivided face points generated by iterating through the faces of the mesh that are tagged as to be subdivided. Next, the partially subdivided mesh can be generated by iterating through the vertices of the mesh that are tagged as to be subdivided. For the vertices tagged as to be subdivided, subdivided vertices can be generated using stencil points and stencil weights based on the vertices tagged as to be subdivided, the subdivided edge points generated by iterating through the edges of the mesh that are tagged as to be subdivided, and the subdivided face points that are generated by iterating through the faces of the mesh that are tagged as to be subdivided. Based on the subdivided face points, the subdivided edge points, and the subdivided vertices, subdivided surfaces can be generated for the mesh. The partially subdivided mesh can be generated based on the subdivided surfaces. Many variations are possible.

In some instances, multiple levels of partial subdivision can be generated. For example, a portion of a base level mesh can be subdivided to generate a partially subdivided mesh with one level of subdivision. A portion of the subdivided portion of the partially subdivided mesh can be further subdivided to generate a partially subdivided mesh with two levels of subdivision. The portion of the subdivided portion of the partially subdivided mesh can have two levels of subdivision and other portions of the subdivided portion of the partially subdivided mesh can have one level of subdivision. Many variations are possible.

In some instances, adaptive subdivision schemes can be applied to generate partially subdivided meshes. For example, an adaptive subdivision scheme can automatically subdivide regular faces, or quadrilateral faces with ordinary valence vertices (e.g., vertices with valence of four) at one level of subdivision. The automatically subdivided regular faces can be rendered as bicubic B-spline patches. Faces with extraordinary valence vertices (e.g., vertices with valence different from four) can be automatically subdivided at multiple levels of subdivision (e.g., at least two levels of subdivision). As another example, an adaptive subdivision scheme can maintain hierarchical subdivisions for a partially subdivided mesh. Edits to the partially subdivided mesh can be applied at different levels of subdivisions of the partially subdivided mesh based on a hierarchy of the hierarchical subdivisions. Many variations are possible.

As illustrated in FIG. 1, the partial subdivision module 102 can include a tessellation module 108. The tessellation module 108 can generate a tessellation (e.g., triangle mesh) based on a mesh or a partially subdivided mesh. The mesh or the partially subdivided mesh can include faces of three or more sides, including quadrilaterals, pentagons, and the like. The tessellation can be generated by dividing faces of the mesh or the partially subdivided mesh until all faces of the mesh or the partially subdivided mesh are triangular faces. For meshes that are not partially subdivided (e.g., fully subdivided meshes, base level meshes), tessellations can be generated by dividing the faces of the meshes in any order. For partially subdivided meshes, tessellations can also be generated by dividing the faces of the meshes in any order, but artifacts may be introduced. Specific tessellations for partially subdivided meshes can be generated by dividing the faces of the partially subdivided meshes in a suitable order based on various approaches that avoid degenerate triangle faces, detached surfaces, unaligned surfaces, and surface discontinuities. Degenerate triangle faces, detached surfaces, unaligned surfaces, and surface discontinuities can result in unnatural or extreme protrusions and undesirable visual artifacts when rendered.

In one approach to generating a tessellation of a partially subdivided mesh, predefined tessellation rules can be applied for corresponding predefined cases of face configurations. For each possible face configuration, a corresponding predefined tessellation rule can be applied to divide the face to generate a tessellation. In some instances, each possible face configuration can be mapped to a predefined tessellation so that each possible face configuration has a corresponding predefined set of tessellated faces. For example, one possible face configuration is a polygonal quadrilateral face with two adjacent sides of the polygonal quadrilateral face bordering subdivided faces. For this face configuration, a predefined tessellation rule can determine that the polygonal quadrilateral face is to be divided by a line using a vertex located between the two adjacent sides of the polygonal quadrilateral face bordering the subdivided faces. This can prevent formation of a triangle mesh with two sides bordering the subdivided faces. Dividing the polygonal quadrilateral face based on the predefined tessellation rule can avoid generating a tessellation with degenerate triangle faces, detached surfaces, unaligned surfaces, surface discontinuities, and visual artifacts.

In one approach to generating a tessellation of a partially subdivided mesh, faces of a partially subdivided mesh are tessellated based on identification of face vertices and subdivided edge vertices. The face vertices and the subdivided edge vertices can be identified automatically based on tags associated with faces, edges, and vertices of the partially subdivided mesh and information related to generation of the partially subdivided mesh. The generated tessellation of the partially subdivided mesh can include triangles that connect subdivided edge vertices with polygonal edge vertices. In this approach, a recursive process is applied to a partially subdivided mesh to generate a set of tessellated faces based on an ordered list of face vertices, and an ordered list of face vertices that are subdivided edge vertices. The recursive process can include three base cases: (1) a face has one or two vertices; (2) a face has three face vertices; and (3) a face has more than three face vertices and none of the face vertices are subdivided edge vertices. In the first base case, the recursive process reaches a face that is a degenerate face. The degenerate face is skipped and flagged as an error. In the second base case, the recursive process reaches a face that is a triangle face. The triangle face is included in the set of tessellated faces generated for the partially subdivided mesh. In the third base case, the recursive process reaches a face that can be divided into triangles in any order. This is consistent with tessellating a fully subdivided mesh or a base level mesh. In a non-base case, the recursive process reaches a face with face vertices that include polygonal edge vertices and subdivided edge vertices. In the non-base case, the recursive processes begin with a face vertex in the ordered list of face vertices that are subdivided edge vertices. A triangle face is generated on the face vertex and the next two face vertices in the ordered list of face vertices. The next two face vertices in the ordered list of face vertices can be the next two adjacent face vertices in a clockwise or a counter-clockwise direction. The triangle face is added to the set of tessellated faces generated for the partially subdivided mesh. The face vertex that is a subdivided edge vertex is removed from the ordered list of face vertices that are subdivided edge vertices. The next face vertex in the ordered list of face vertices is removed from the ordered list of face vertices. This avoids additional triangle faces from being generated based on the face vertex. The ordered list of face vertices that are subdivided edge vertices and the ordered list of face vertices are adjusted based on the removal of the face vertex that is a subdivided edge vertex and the next face vertex. The recursive process repeats the non-base case until the recursive processes reaches one of the three base cases. As pseudocode, the recursive process for the non-base case can be provided as:

| | |
|---|---|
| 1. | Start with a face vertex (vᵢ) where i is an index for an ordered list |

of face vertices and vᵢ is a subdivided edge vertex (e₀) in an ordered list of
face vertices that are subdivided edge vertices;

| | |
|---|---|
| 2. | Create a triangle face with the following vertices [vᵢ, v_{(i+1)%n}, v_{(i+2)%n}] |

where v_{(i+1)%n} and v_{(i+2)%n} are vertices from the ordered list of face vertices
and % is the modulo function; add the triangle face to an output set of
tessellated faces;

| | |
|---|---|
| 3. | Remove v_{(i+1) % n} from the ordered list of face vertices; |
| 4. | Remove e₀ from the ordered list of face vertices that are subdivided |

edge vertices; adjust the ordered list of face vertices and the ordered list
of face vertices that are subdivided edge vertices for the removed
vertices v_{(i+1) % n} and e₀;

| | |
|---|---|
| 5. | Recurse. |

The recursive process can be modified to generate alternative valid tessellations. For example, the recursive process can be performed without removing face vertices that are subdivided edge vertices. Without removing the face vertices that are subdivided edge vertices, the face vertices can be used and reused to generate triangle faces. An alternative valid tessellation can be generated based on these triangle faces. For example, the recursive process can be performed using the first face vertex that is a subdivided edge vertex as the first vertex for generating a triangle face for a face and the last vertex for generating a triangle face for the face. An alternative valid tessellation can be generated based on the triangle faces using the first face vertex that is a subdivided edge vertex. Many variations are possible.

The recursive process can be applied at different levels of subdivision. For a mesh with multiple subdivision levels, the recursive process can be applied at a first subdivision level based on subdivided faces, edges, and vertices generated for the first subdivision level. The recursive process can be applied next at a second subdivision level based on subdivided faces, edges, and vertices generated for the second subdivision level. The recursive processes can be applied to subsequent subdivision levels in an order of the subdivision levels based on subdivided faces, edges, and vertices generated for the respective subdivision level. For example, a base level mesh can be partially subdivided twice to generate a partially subdivided mesh with two levels of subdivision. A tessellation of the partially subdivided mesh can be generated by applying a recursive process to the partially subdivided mesh based on subdivided faces, edges, and vertices associated with the first level of subdivision. The tessellation of the partially subdivided mesh generated based on the subdivided faces, edges, and vertices associated with the first level of subdivision can be further tessellated based on subdivided faces, edges, and vertices associated with the second level of subdivision. The further tessellation of the partially subdivided mesh can be a valid tessellation of the partially subdivided mesh that incorporates the subdivided faces, edges, and vertices of the first level of subdivision and the second level of subdivision. Many variations are possible.

Generating a tessellation of a partially subdivided mesh can be based on the approaches described herein individually or in combination. For example, a tessellation of a partially subdivided mesh can be generated based on a set of predefined tessellation rules for predefined cases of face configurations. In this example, the set of predefined tessellation rules may not cover all possible cases of face configurations. A recursive process for generating the tessellation of the partially subdivided mesh can be applied to cases of face configurations that are not covered by the set of predefined tessellation rules. This combination of approaches may provide for efficient tessellation based on predefined tessellation rules and easily scalable tessellation based on a recursive process that covers cases not covered by the predefined tessellation rules. In some instances, multiple tessellations of a partially subdivided mesh can be generated based on various approaches and combinations of approaches described herein. The multiple tessellations can be provided for a user to select a preferred tessellation. The preferred tessellation selected by the user may be more aesthetically pleasing than the other tessellations or may be more appropriate for a given use case than the other tessellations. In some instances, an approach or a combination of approaches for generating a tessellation of a partially subdivided mesh can be determined based on a surface of the partially subdivided mesh or other characteristics associated with the partially subdivided mesh. A tessellation generated by a particular approach may have an aesthetic effect that is more suitable for a type of surface than other tessellations generated by other approaches. Many variations are possible.

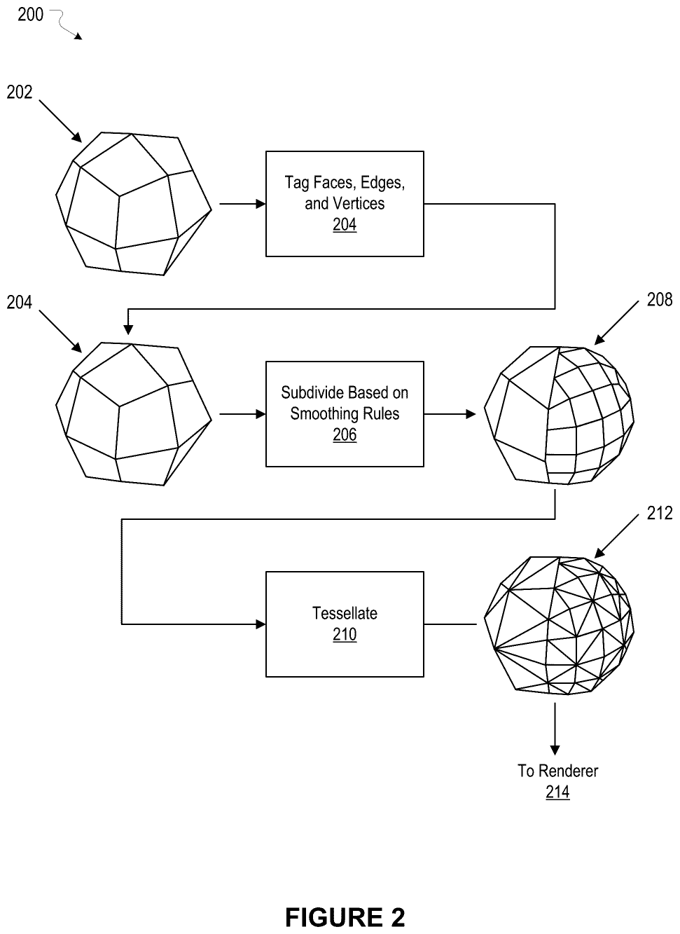

FIG. 2 illustrates an example block diagram 200 related to partial subdivision surfaces, according to various embodiments of the present technology. Various functions illustrated in the example block diagram 200 can be performed, for example, by the example system 100 of FIG. 1. It should be understood that there can be additional, fewer, or alternative steps performed in similar or alternative orders, or in parallel, based on the various features discussed herein unless otherwise stated. All examples herein are provided for illustrative purposes, and there can be many variations and other possibilities.

As illustrated in FIG. 2, a base level mesh 202 of a 3D ball can be provided for partial subdivision. The 3D ball is merely an example. The present technology can be applied to any 3D object. At 204, faces, edges, and vertices of the base level mesh are tagged. The tags can indicate which of the faces, edges, and vertices of the base level mesh 202 are to be subdivided and which of the faces, edges, and vertices of the base level mesh 202 are polygonal. In this example, a half of the base level mesh 202 can be tagged as to be subdivided and another half of the base level mesh 202 can be tagged as polygonal. Based on the tags, a tagged base level mesh 204 of the 3D ball can be generated. At 206, the tagged base level mesh 204 of the 3D ball can be subdivided based on smoothing rules. In this example, the smoothing rules can be applied to generate a subdivided mesh based on the half of the base level mesh 202 that is tagged as to be subdivided. Based on the subdivided mesh, a partially subdivided mesh 208 of the 3D ball can be generated. At 210, the partially subdivided mesh 208 can be tessellated. A tessellation 212 of the partially subdivided mesh 208 can be generated. In this example, the tessellation 212 is a triangle mesh generated based on the partially subdivided mesh 208. At 214, the tessellation 212 can be provided to a renderer. The 3D ball can be rendered based on the tessellation 212. As illustrated in this example, a half of the 3D ball corresponding with the half of the base level mesh 202 that was tagged as to be subdivided can be rendered using more polygons than another half of the 3D ball corresponding with the other half of the base level mesh 202 that was tagged as polygonal. Many variations are possible.

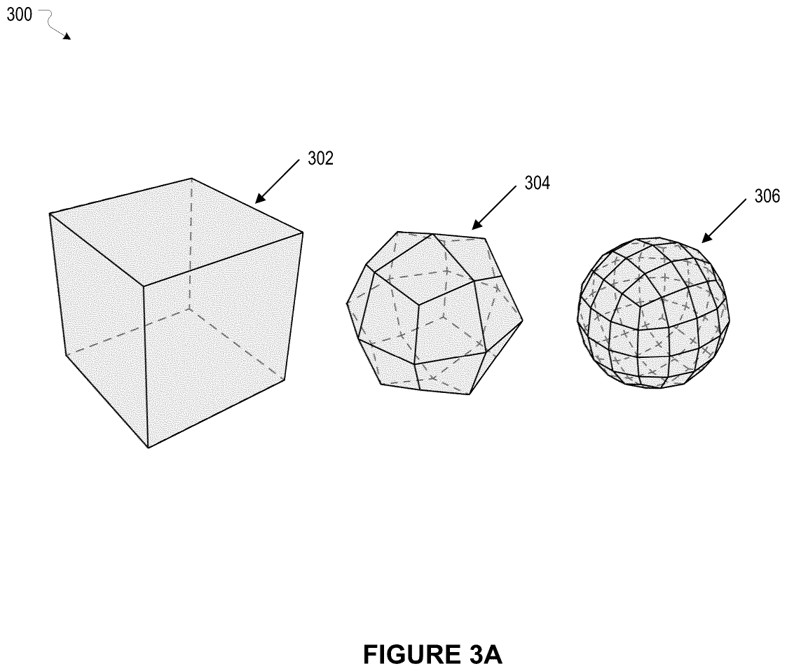

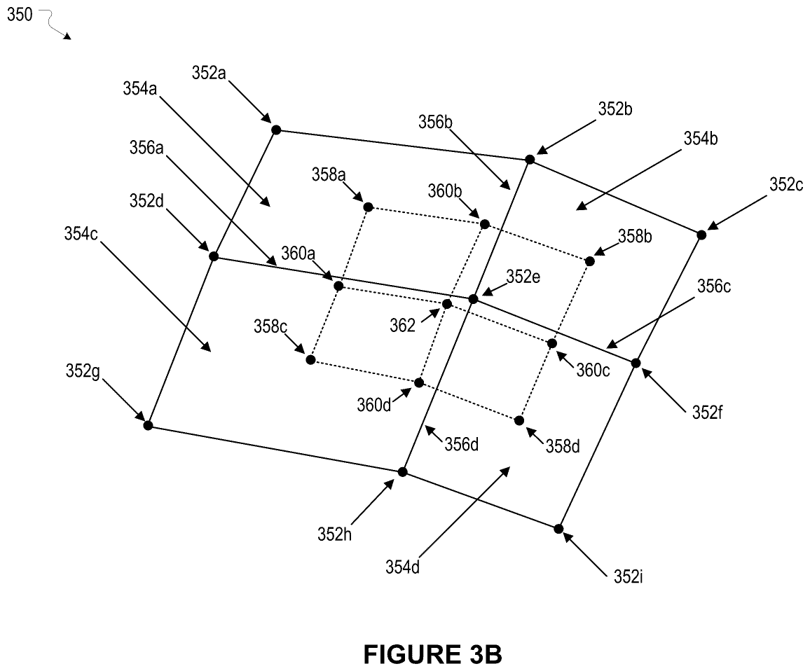

FIGS. 3A-3B illustrate examples related to subdivision surfaces, according to various embodiments of the present technology. Various functions illustrated in the examples can be performed, for example, by the example system 100 of FIG. 1. It should be understood that there can be additional, fewer, or alternative steps performed in similar or alternative orders, or in parallel, based on the various features discussed herein unless otherwise stated. All examples herein are provided for illustrative purposes, and there can be many variations and other possibilities.

FIG. 3A illustrates an example 300 of multiple levels of subdivision. As illustrated in FIG. 3A, a base level mesh 302 or an input control mesh can be subdivided to generate a first subdivided mesh 304. In this example, each face of the base level mesh 302 is split into a first set of subdivided faces or subfaces. The split of the base level mesh 302 into the first set of subdivided faces can be based on first stencil points (e.g., faces, edges, and vertices) of the base level mesh 302 and associated first stencil weights. The first subdivided mesh 304 can have one level of subdivision. The first subdivided mesh 304 can be subdivided to generate a second subdivided mesh 306. In this example, each face of the first subdivided mesh 304 is split into a second set of subdivided faces. The split of the first subdivided mesh 304 into the second set of subdivided faces can be based on second stencil points of the first subdivided mesh 304 and associated second stencil weights. The second subdivided mesh 306 can have two levels of subdivision. As illustrated in this example, subdivision can be applied to a mesh of surfaces to progressively refine and smooth the mesh of surfaces. Many variations are possible.

FIG. 3B illustrates an example 350 of generating subdivided vertices for a mesh. As illustrated in FIG. 3B, a mesh can include four faces 354a, 354b, 354c, 354d and four edges 356a, 356b, 356c, 356d incident to a vertex 352e. In this example, the four faces 354a, 354b, 354c, 354d are quadrilaterals with vertices 352a, 352b, 352c, 352d, 352e, 352f, 352g, 352h, 352i. Subdivided vertices for subdividing the mesh can be generated by iterating through the faces first, then the edges second, and the vertices third. For faces, subdivided face vertices can be generated based on a weighted centroid determined from vertices of the faces. In this example, for the first face 354a, a first subdivided face vertex 358a can be generated based on a weighted centroid determined from vertices 352a, 352b, 352d, 352e. For the second face 354b, a second subdivided face vertex 358b can be generated based on a weighted centroid determined from vertices 352b, 352c, 352e, 352f. For the third face 354c, a third subdivided face vertex 358c can be generated based on a weighted centroid determined from vertices 352d, 352e, 352g, 352h. For the fourth face 354d, a fourth subdivided face vertex 358d can be generated based on a weighted centroid determined from vertices 352e, 352f, 352h, 352i. Next, for edges, subdivided edge vertices can be generated based on a weighted combination determined from centroids of the edges and weighted combinations of incident faces (e.g., the subdivided face vertices). In this example, for the first edge 356a, a first subdivided edge vertex 360a can be generated based on a weighted combination determined from a centroid of the first edge 356a, the first subdivided face vertex 358a, and the third subdivided face vertex 358c. For the second edge 356b, a second subdivided edge vertex 360b can be generated based on a weighted combination determined from a centroid of the second edge 356b, the first subdivided face vertex 358a, and the second subdivided face vertex 358b. For the third edge 356c, a third subdivided edge vertex 360c can be generated based on a weighted combination determined from a centroid of the third edge 356c, the second subdivided face vertex 358b, and the fourth subdivided face vertex 358d. For the fourth edge 356d, a fourth subdivided edge vertex 360d can be generated based on a weighted combination determined from a centroid of the fourth edge 356d, the third subdivided face vertex 358c, and the fourth subdivided face vertex 358d. Next, for vertices, subdivided vertices can be generated based on a weighted combination determined from weighted combinations of incident faces (e.g., subdivided face vertices), weighted combinations of incident edges (e.g., edge vertices), and the weighted combination of the vertex In this example, for the vertex 352e, a subdivided vertex 362 can be generated based on a weighted combination determined from the subdivided face vertices 358a, 358b, 358c, 358d, the edge vertices 352d, 352b, 352f, 352h, and the vertex 352e. Based on vertices including the subdivided face vertices 358a, 358b, 358c, 358d, the subdivided edge vertices 360a, 360b, 360c, 360d, and the subdivided vertex 362, a subdivided mesh can be generated. Many variations are possible.

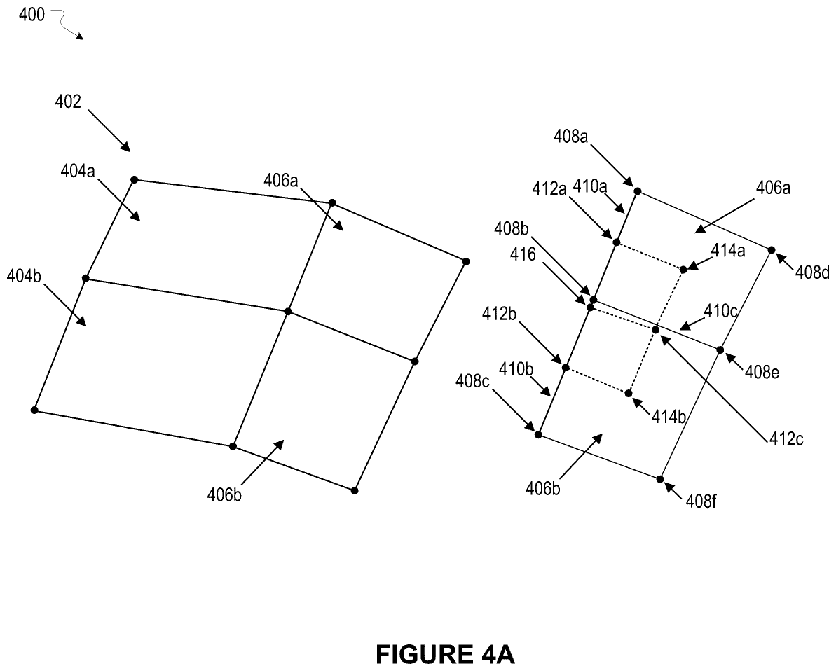

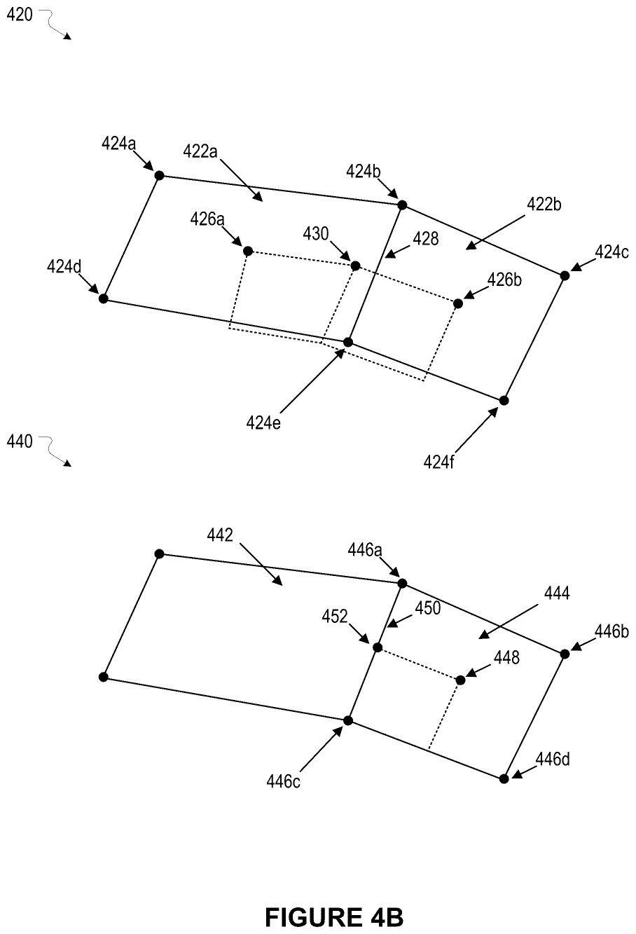

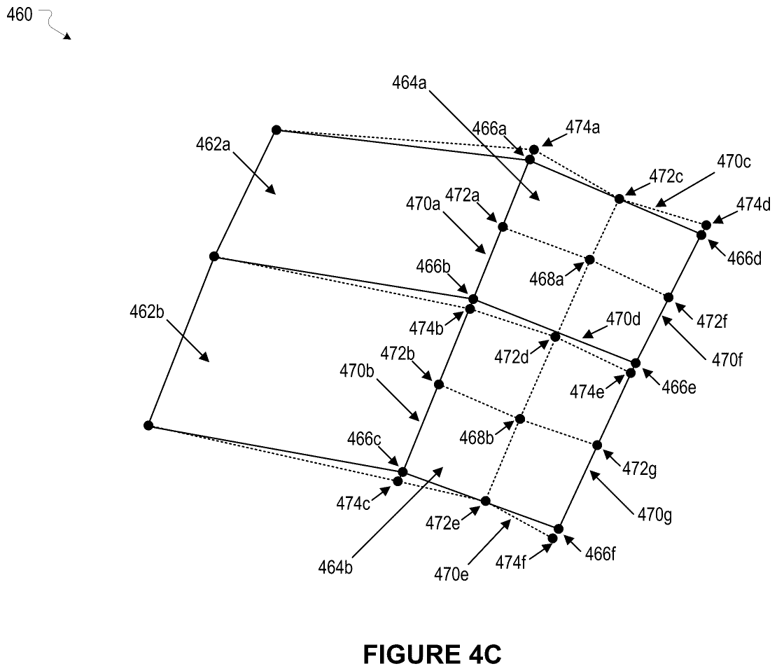

FIGS. 4A-4C illustrate examples related to partial subdivision surfaces, according to various embodiments of the present technology. Various functions illustrated in the examples can be performed, for example, by the example system 100 of FIG. 1. It should be understood that there can be additional, fewer, or alternative steps performed in similar or alternative orders, or in parallel, based on the various features discussed herein unless otherwise stated. All examples herein are provided for illustrative purposes, and there can be many variations and other possibilities.

FIG. 4A illustrates an example 400 of partially subdividing a mesh 402. As illustrated in FIG. 4A, the mesh 402 can include four faces 404a, 404b, 406a, 406b. In this example, the faces 404a, 404b are polygonal. The faces 406a, 406b are to be subdivided. Subdivided vertices for a partially subdivided mesh can be generated by iterating through faces to be subdivided first, then edges to be subdivided second, and vertices to be subdivided third. Polygonal faces, edges, and vertices are skipped. For faces, subdivided face vertices can be generated based on a weighted centroid determined from vertices of the faces. In this example, for the first face 406a to be subdivided, a first subdivided face vertex 414a can be generated based on a weighted centroid determined from vertices 408a, 408b, 408d, 408e. For the second face 406b to be subdivided, a second subdivided face vertex 414b can be generated based on a weighted centroid determined from vertices 408b, 408c, 408e, 408f. Next, for edges to be subdivided, subdivided edge vertices can be generated based on smoothing rules applied based on the edges to be subdivided. In this example, for the first edge 410a to be subdivided, a first subdivided edge vertex 412a can be generated based on smoothing rules for an edge that has one incident face to be subdivided and one incident polygonal face. Based on the smoothing rules, the first subdivided edge vertex 412a can be generated based on a weighted combination determined from the vertices 408a, 408b. For the second edge 410b to be subdivided, a second subdivided edge vertex 412b can be generated based on smoothing rules for an edge that has one incident face to be subdivided and one incident polygonal face. Based on the smoothing rules, the second subdivided edge vertex 412b can be generated based on a weighted combination determined from the vertices 408b, 408c. For the third edge 410c to be subdivided, a third subdivided edge vertex 412c can be generated based on smoothing rules for an edge with two incident faces to be subdivided. Based on the smoothing rules, the third subdivided edge vertex 412c can be generated based on a weighted combination determined from the vertices 408b, 408e and the subdivided face vertices 414a, 414b. Next, for vertices to be subdivided, subdivided vertices can be generated based on smoothing rules applied based on the vertices to be subdivided. In this example, for the vertex 408b to be subdivided, a subdivided vertex 416 can be generated based on smoothing rules for a vertex that has two incident faces to be subdivided and three incident edges to be subdivided. Based on the smoothing rules, the subdivided vertex can be generated based on a weighted combination determined from the vertex 408b and the edge vertices 408a, 408c. Based on vertices including the subdivided face vertices 414a, 414b, the subdivided edge vertices 412a, 412b, 412c, and the subdivided vertex 416, a partially subdivided mesh can be generated. Many variations are possible.

FIG. 4B illustrates an example 420 of subdividing a mesh and an example 440 of partially subdividing a mesh. As illustrated in the example 420, a mesh can include two faces 422a, 422b. In this example, the faces 422a, 422b are to be subdivided. Subdivided vertices for a subdivided mesh can be generated by iterating through faces first, then edges second, and vertices third. For faces, subdivided face vertices can be generated based on a weighted centroid determined from vertices of the faces. In this example, for the first face 422a to be subdivided, a first subdivided face vertex 426a can be generated based on a weighted centroid determined from vertices 424a, 424b, 424d, 424e. For the second face 422b to be subdivided, a second subdivided face vertex 426b can be generated based on a weighted centroid determined from vertices 424b, 424c, 424e, 424f. Next, for edges, subdivided edge vertices can be generated based on a weighted combination determined from centroids of the edges and weighted combinations of incident faces (e.g., subdivided face vertices). In this example, for the edge 428, a subdivided edge vertex 430 can be generated based on a weighted combination determined from a centroid of the edge 428, the first subdivided face vertex 426a, and the second subdivided face vertex 426b. Based on vertices including the subdivided face vertices 426a, 426b and the subdivided edge vertex 430, a subdivided mesh can be generated. Many variations are possible.

As illustrated in the example 440, a mesh can include two faces 442, 444. In this example, the face 442 is polygonal and the face 444 is to be subdivided. Subdivided vertices for a partially subdivided mesh can be generated by iterating through faces to be subdivided first, then edges to be subdivided second, and vertices to be subdivided third. Polygonal faces, edges, and vertices are skipped. For faces, subdivided face vertices can be generated based on a weighted combination determined from vertices of the faces. In this example, for the face 444 to be subdivided, a subdivided face vertex 448 can be generated based on a weighted combination determined from vertices 446a, 446b, 446c, 446d. Next, for edges to be subdivided, subdivided edge vertices can be generated based on smoothing rules applied based on the edges to be subdivided. In this example, for edge 450, a subdivided edge vertex 452 can be generated based on smoothing rules for an edge that has one incident face to be subdivided and one incident polygonal face. Based on the smoothing rules, the subdivided edge vertex 452 can be generated based on a weighted combination determined from the vertices 446a, 446c. Based on vertices including the subdivided face vertex 448 and the subdivided edge vertex 452, a partially subdivided mesh can be generated. As illustrated in this example, application of smoothing rules for partially subdivided meshes can facilitate generate of subdivided vertices that correctly connect polygonal surfaces with subdivided surfaces without gaps or intrusions. Many variations are possible.

FIG. 4C illustrates an example 460 of partially subdividing a mesh. As illustrated in FIG. 4C, the mesh includes four faces 462a, 462b, 464a, 464b. In this example, the faces 462a, 462b are polygonal. The faces 464a, 464b are to be subdivided. Subdivided vertices for a partially subdivided mesh can be generated by iterating through faces to be subdivided first, then edges to be subdivided second, and vertices to be subdivided third. Polygonal faces, edges, and vertices are skipped. For faces, subdivided face vertices can be generated based on a weighted centroid determined from vertices of the faces. In this example, for the first face 464a to be subdivided, a first subdivided face vertex 468a can be generated based on a weighted centroid determined from vertices 466a, 466b, 466d, 466e. For the second face 464b to be subdivided, a second subdivided face vertex 468b can be generated based on a weighted centroid determined from vertices 466b, 466c, 466e, 466f. Next, for edges to be subdivided, subdivided edge vertices can be generated based on smoothing rules applied based on the edges to be subdivided. In this example, for the first edge 470a to be subdivided, a first subdivided edge vertex 472a can be generated based on smoothing rules for an edge that has one incident face to be subdivided and one incident polygonal face. Based on the smoothing rules, the first subdivided edge vertex 472a can be generated based on a weighted combination determined from the vertices 466a, 466b. For the second edge 470b to be subdivided, a second subdivided edge vertex 472b can be generated based on smoothing rules for an edge that has one incident face to be subdivided and one incident polygonal face. Based on the smoothing rules, the second subdivided edge vertex 472b can be generated based on a weighted combination determined from the vertices 466b, 466c. For the third edge 470c to be subdivided, a third subdivided edge vertex 472c can be generated based on smoothing rules for a border edge or an edge that has one incident face to be subdivided. Based on the smoothing rules, the third subdivided edge vertex can be generated based on a weighted combination determined from the vertices 466a, 466d. For the fourth edge 470d to be subdivided, a fourth subdivided edge vertex 472d can be generated based on smoothing rules for an edge that has two incident faces to be subdivided and no edge creasing. Based on the smoothing rules, the fourth subdivided edge vertex 472d can be generated based on a weighted combination determined from the vertices 466b, 466e and the subdivided face vertices 468a, 486b. For the fifth edge 470e to be subdivided, a fifth subdivided edge vertex 472e can be generated based on smoothing rules for a border edge or an edge that has one incident face to be subdivided. Based on the smoothing rules, the fifth subdivided edge vertex can be generated based on a weighted combination determined from the vertices 466c, 466f. For the sixth edge 470f to be subdivided, a sixth subdivided edge vertex 472f can be generated based on smoothing rules for a border edge or an edge that has one incident face to be subdivided. Based on the smoothing rules, the sixth subdivided edge vertex can be generated based on a weighted combination determined from the vertices 466d, 466e. For the seventh edge 470g to be subdivided, a seventh subdivided edge vertex 472g can be generated based on smoothing rules for a border edge or an edge that has one incident face to be subdivided. Based on the smoothing rules, the seventh subdivided edge vertex can be generated based on a weighted combination determined from the vertices 466e, 466f. Next, for vertices to be subdivided, subdivided vertices can be generated based on smoothing rules applied based on the vertices to be subdivided. In this example, for the first vertex 466a to be subdivided, a first subdivided vertex 474a can be generated based on smoothing rules for a vertex that has one incident face to be subdivided and two incident edges to be subdivided. Based on the smoothing rules, the first subdivided vertex 474a can be generated based on the first vertex 466a (e.g., the first subdivided vertex 474a has the same position as the first vertex 466a). In this example, the first subdivided vertex 474a can have the same location as the first vertex 466a. For the second vertex 466b to be subdivided, a second subdivided vertex 474b can be generated based on smoothing rules for a vertex that has two incident faces to be subdivided and three incident edges to be subdivided. Based on the smoothing rules, the second subdivided vertex 474b can be generated based on a weighted combination determined from the second vertex 466b and the edge vertices 466a, 466c. For the third vertex 466c to be subdivided, a third subdivided vertex 474c can be generated based on smoothing rules for a vertex that has one incident face and two incident edges. Based on the smoothing rules, the third subdivided vertex 474c can be generated based on the third vertex 466c. In this example, the third subdivided vertex 474c can have the same location as the third vertex 466c. For the fourth vertex 466d to be subdivided, a fourth subdivided vertex 474d can be generated based on smoothing rules for a vertex that has one incident face and two incident edges. Based on the smoothing rules, the fourth subdivided vertex 474d can be generated based on the fourth vertex 466d. In this example, the fourth subdivided vertex 474d can have the same location as the fourth vertex 466d. For the fifth vertex 466e to be subdivided, a fifth subdivided vertex 474e can be generated based on smoothing rules for a vertex that has two incident faces to be subdivided and three incident edges to be subdivided. Based on the smoothing rules, the fifth subdivided vertex 474e can be generated based on a weighted combination determined from the fifth vertex 466e and the edge vertices 474d, 466f. In this example, the fifth subdivided vertex 474e can have the same location as the fifth vertex 474e. For the sixth vertex 466f to be subdivided, a sixth subdivided vertex 474f can be generated based on smoothing rules for a vertex that has one incident face and two incident edges. Based on the smoothing rules, the sixth subdivided vertex 474f can be generated based on the sixth vertex 466f. In this example, the sixth subdivided vertex 474f can have the same location as the sixth vertex 466f. It should be understood that the subdivided vertices 474a, 474d, 474e, 474f are at the same locations as the vertices 466a, 466d, 466e, 466f, respectively. Based on vertices including the subdivided face vertices 468a, 468b, the subdivided edge vertices 472a, 472b, 472c, 472d, 472e, 472f, 472g, and the subdivided vertices 474a, 474b, 474c, 474d, 474e, 474f, a partially subdivided mesh can be generated. Many variations are possible.

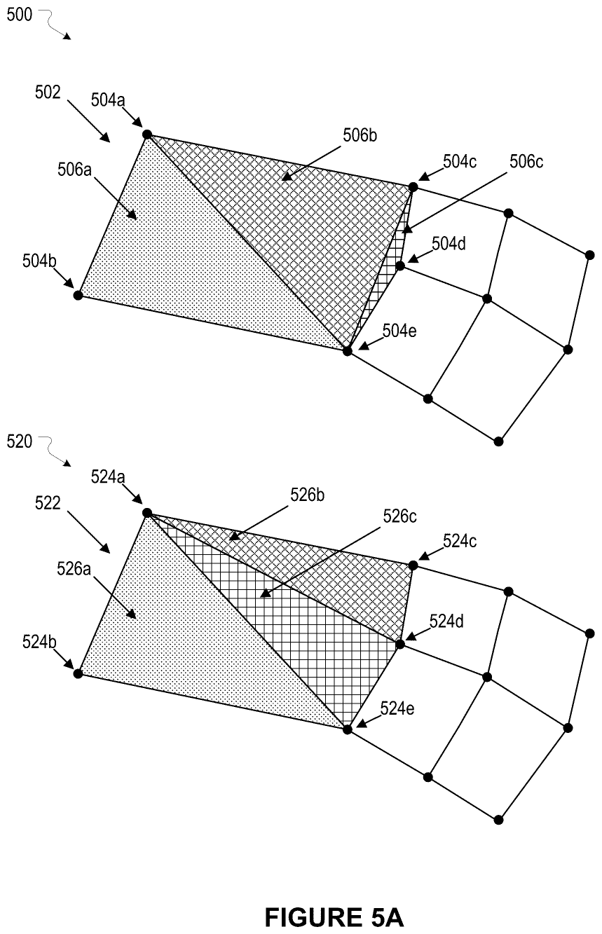

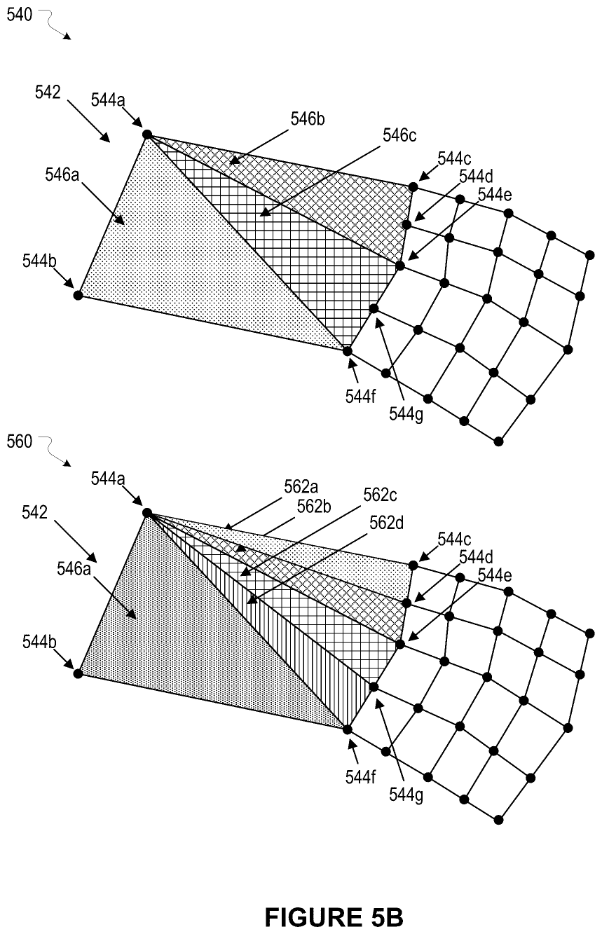

FIGS. 5A-5B illustrate examples related to tessellation of partially subdivided surfaces, according to various embodiments of the present technology. Various functions illustrated in the examples can be performed, for example, by the example system 100 of FIG. 1. It should be understood that there can be additional, fewer, or alternative steps performed in similar or alternative orders, or in parallel, based on the various features discussed herein unless otherwise stated. All examples herein are provided for illustrative purposes, and there can be many variations and other possibilities.

FIG. 5A illustrates an example 500 of tessellating a partially subdivided mesh and an example 520 of tessellating a partially subdivided mesh. The example 500 illustrates a partially subdivided mesh with a pentagonal face 502 with vertices 504a, 504b, 504c, 504d, 504e. A tessellation of the pentagonal face 502 can generated by dividing the pentagonal face 502 into triangle faces 506a, 506b, 506c. In this example, the triangle face 506c is a degenerate triangle face. As the mesh is deformed, the triangle face 506c may move off a plane associated with the triangle face 506b. When the triangle face 506c moves off the plane associated with the triangle face 506b, surface discontinuities and visual artifacts may appear. As illustrated in this example, conventional tessellation of a partially subdivided mesh can result in degenerate triangle faces.

The example 520 illustrates a partially subdivided mesh with a pentagonal face 522 with vertices 524a, 524b, 524c, 524d, 524e. A tessellation of the pentagonal face 522 can be generated by dividing the pentagonal face 522 based on predefined tessellation rules, a recursive process for tessellating partially subdivided meshes, or a combination of the predefined tessellation rules and the recursive process. In this example, the recursive process can be applied to the pentagonal face 522. As part of the recursive process, an ordered list of face vertices in a counter-clockwise direction (e.g., the vertices 524a, 524b, 524e, 524d, 524c) can be generated. An ordered list of subdivided edge vertices in a counter-clockwise direction (e.g., the vertex 524d) can be generated. A determination is made that the recursive process is in a non-base case. For the non-base case, the recursive process begins with the first subdivided edge vertex 524d in the ordered list of subdivided edge vertices and generates a triangle face 526b based on the first subdivided edge vertex 524d and the next two adjacent vertices in the ordered list of face vertices (e.g., the vertices 524c, 524a). The vertex 524c is removed from the ordered list of face vertices. The vertex 524d is removed from the ordered list of subdivided edge vertices. A determination is made that the recursive process is in a base case. The base case corresponds with a face that has more than three vertices and no subdivided edge vertices. In the base case, the recursive process tessellates by dividing the face (e.g., formed by the vertices 524a, 524b, 524e, 524d) into two triangles in any order. In this example, the recursive process tessellates using the vertices 524a, 524e, 524d to generate a triangle face 526c and the vertices 524a, 524b, 524e to generate a triangle face 526a. A tessellation including triangle faces 526a, 526b, 526c can be rendered for display. As illustrated in this example, tessellation of a partially subdivided mesh using a recursive process for tessellating partially subdivided meshes can avoid generate of degenerate triangle faces. Many variations are possible.

FIG. 5B illustrates an example 540 of tessellating a partially subdivided mesh with multiple levels of subdivision and an example 560 of tessellating the partially subdivided mesh with multiple levels of subdivision. The example 540 illustrates the partially subdivided mesh with a heptagonal face 542 with vertices 544a, 544b, 544c, 544d, 544e, 544f, 544g. The heptagonal face 542 is generated based on the partially subdivided mesh having two levels of subdivision. A tessellation of the heptagonal face 542 can be generated by dividing the heptagonal face 542 at a first subdivision level and then dividing the resulting faces at a second subdivision level. In this example, the tessellation of the heptagonal face 542 can be generated based on a recursive process for tessellating partially subdivided meshes applied at the first subdivision level. At the first subdivision level, an ordered list of face vertices in a counter-clockwise direction can include the vertices 544a, 544b, 544f, 544e, 544c. An ordered list of subdivided edge vertices in a counter-clockwise direction can include the vertex 544e. A determination is made that the recursive process is in a non-base case. For the non-base case, the recursive process begins with the first subdivided edge vertex 544e in the ordered list of subdivided edge vertices and generates a triangle face 546b based on the first subdivided edge vertex 544e and the next two adjacent vertices in the ordered list of face vertices (e.g., the vertices 544c, 544a). The vertex 544c is removed from the ordered list of face vertices. The vertex 544e is removed from the ordered list of subdivided edge vertices. A determination is made that the recursive process is in a base case. The base case corresponds with a face that has more than three vertices and no subdivided edge vertices. In the base case, the recursive process tessellates by dividing the face into two triangles in any order. In this example, the recursive process tessellates using the vertices 544a, 544b, 544f to generate a triangle face 546a and the vertices 544f, 544e, 544a to generate a triangle face 546c. The tessellation of the heptagonal face 524 at the first level of subdivision can include the triangle faces 546a, 546b, 546c.

The example 560 illustrates the partially subdivided mesh with the heptagonal face 542 with the vertices 544a, 544b, 544c, 544d, 544e, 544f, 544g. A tessellation of the heptagonal face 542 can be generated by dividing the heptagonal face 542 at a second subdivision level after the heptagonal face 542 has been divided at a first subdivision level. At the second subdivision level, an ordered list of face vertices in a counter-clockwise direction for the face 546c includes the vertices 544a, 544f, 544g, 544e. An ordered list of subdivided edge vertices in a counter-clockwise direction for the face 546c includes the vertex 544g. A determination is made that the recursive process is in a non-base case. For the non-base case, the recursive process begins with the first subdivided edge vertex 544g in the ordered list of subdivided edge vertices and generates a triangle face 562c based on the first subdivided edge vertex 544g and the next two adjacent vertices in the ordered list of face vertices (e.g., the vertices 544e, 544a). The vertex 544e is removed from the ordered list of face vertices. The vertex 544g is removed from the ordered list of subdivided edge vertices. A determination is made that the recursive process is in a base case. The base case corresponds with a face that has three face vertices. In the base case, the recursive process uses the remaining face as a triangle face 562d with the remaining vertices 544a, 544f, 544g. The recursive process can be repeated for the face 546b. At the second level of subdivision, an ordered list of face vertices in a counter-clockwise direction for the face 546b includes the vertices 544a, 544e, 544d, 544c. An ordered list of subdivided edge vertices in a counter-clockwise direction for the face 546b includes the vertex 544d. A determination is made that the recursive process is in a non-base case. For the non-base case, the recursive process begins with the first subdivided edge vertex 544d in the ordered list of subdivided edge vertices and generates a triangle face 562a based on the first subdivided edge vertex 544d and the next two adjacent vertices in the ordered list of face vertices (e.g., the vertices 544c, 544a). The vertex 544c is removed from the ordered list of face vertices. The vertex 544d is removed from the ordered list of subdivided edge vertices. A determination is made that the recursive process is in a base case. The base case corresponds with a face that has three face vertices. In the base case, the recursive process uses the remaining face as a triangle face 562b with the remaining vertices 544a, 544e, 544d. The tessellation of the heptagonal face 524 at the second level of the subdivision can include the triangle faces 546a, 562a, 562b, 562c, 562d. The tessellation can be rendered for display. Many variations are possible.

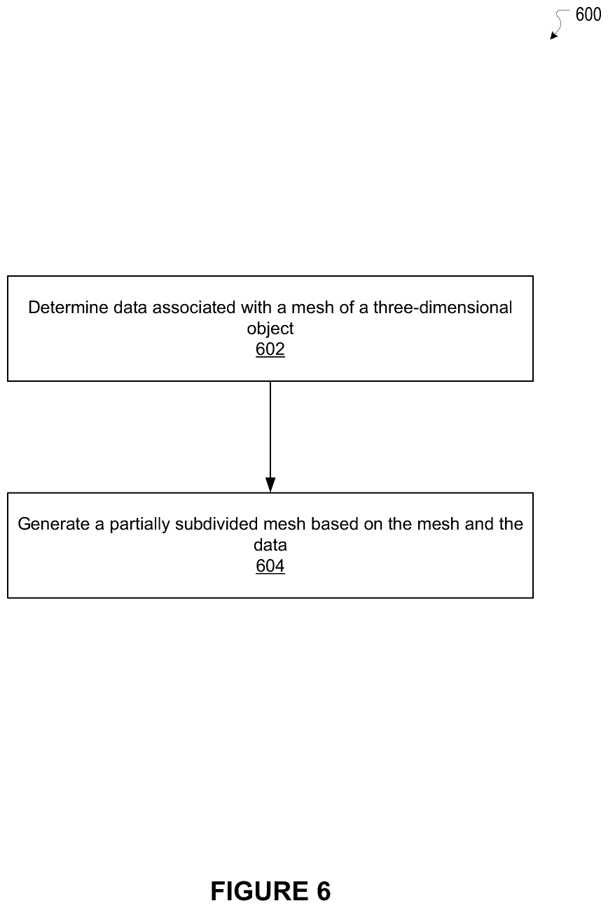

FIG. 6 illustrates an example method 600, according to an embodiment of the present technology. At 602, the example method 600 can determine data associated with a mesh of a three-dimensional object. At 604, the example method 600 can generate a partially subdivided mesh based on the mesh and the data.

Many variations to the example methods are possible. It should be appreciated that there can be additional, fewer, or alternative steps performed in similar or alternative orders, or in parallel, within the scope of the various embodiments discussed herein unless otherwise stated.

### Hardware Implementation

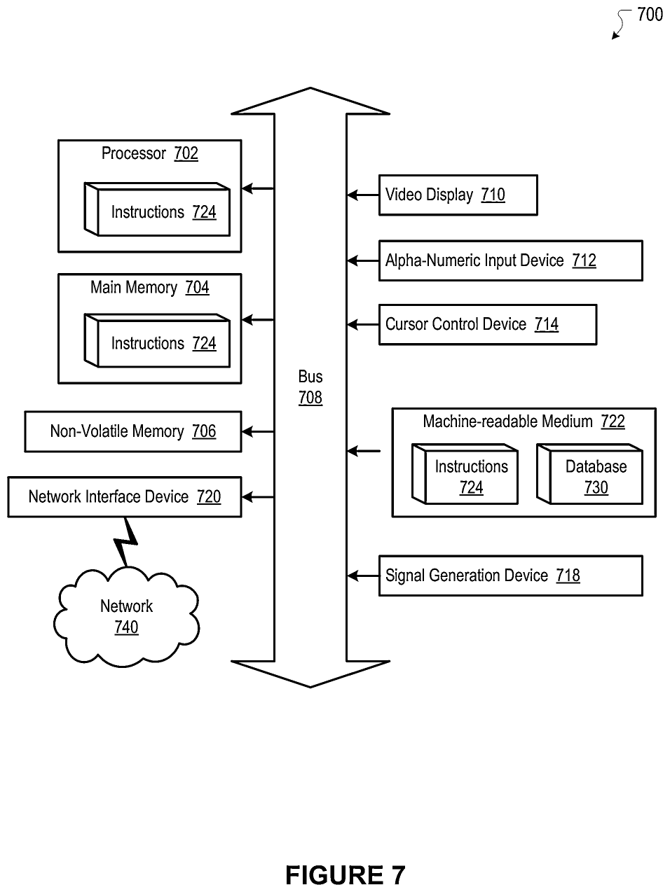

The foregoing processes and features can be implemented by a wide variety of machine and computer system architectures and in a wide variety of network and computing environments. FIG. 7 illustrates an example machine 700 within which a set of instructions for causing the machine to perform one or more of the embodiments described herein can be executed, in accordance with an embodiment of the present technology. The embodiments can relate to one or more systems, methods, or computer readable media. The machine may be connected (e.g., networked) to other machines. In a networked deployment, the machine may operate in the capacity of a server or a client machine in a client-server network environment, or as a peer machine in a peer-to-peer (or distributed) network environment.

The computer system 700 includes a processor 702 (e.g., a central processing unit (CPU), a graphics processing unit (GPU), or both), a main memory 704, and a nonvolatile memory 706 (e.g., volatile RAM and non-volatile RAM, respectively), which communicate with each other via a bus 708. The processor 702 can be implemented in any suitable form, such as a parallel processing system. In some instances, the example machine 700 can correspond to, include, or be included within a computing device or system. For example, in some embodiments, the machine 700 can be a desktop computer, a laptop computer, personal digital assistant (PDA), an appliance, a wearable device, a camera, a tablet, or a mobile phone, etc. In one embodiment, the computer system 700 also includes a video display 710, an alphanumeric input device 712 (e.g., a keyboard), a cursor control device 714 (e.g., a mouse), a signal generation device 718 (e.g., a speaker) and a network interface device 720.

In one embodiment, the video display 710 includes a touch sensitive screen for user input. In one embodiment, the touch sensitive screen is used instead of a keyboard and mouse. A machine-readable medium 722 is used to store one or more sets of instructions 724 (e.g., software) embodying any one or more of the methodologies or functions described herein. The instructions 724 can also reside, completely or at least partially, within the main memory 704 and/or within the processor 702 during execution thereof by the computer system 700. The instructions 724 can further be transmitted or received over a network 740 via the network interface device 720. In some embodiments, the machine-readable medium 722 also includes a database 730.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 706 may also be a random access memory. The non-volatile memory 706 can be a local device coupled directly to the rest of the components in the computer system 700. A non-volatile memory that is remote from the system, such as a network storage device coupled to any of the computer systems described herein through a network interface such as a modem or Ethernet interface, can also be used.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. The term “machine-readable medium” shall accordingly be taken to include, but not be limited to, solid-state memories, optical and magnetic media, and carrier wave signals. The term “storage module” as used herein may be implemented using a machine-readable medium.

In general, routines executed to implement the embodiments of the invention can be implemented as part of an operating system or a specific application, component, program, object, module, or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 700 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually effect the distribution. Examples of machine-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, “in various embodiments,” or the like means that a particular feature, design, structure, or characteristic described in connection with the embodiment is included in at least one embodiment of the disclosure. The appearances of, for example, the phrases “according to an embodiment”, “in one embodiment”, “in an embodiment”, “in various embodiments”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, data associated with a mesh of a three-dimensional object;
generating, by the computing system, a partially subdivided mesh based on the mesh and the data.

2. The computer-implemented method of claim 1, further comprising: causing, by the computing system, generation of a tessellation of the partially subdivided mesh.

3. The computer-implemented method of claim 1, wherein generating the partially subdivided mesh comprises:
generating, by the computing system, subdivided face vertices based on faces of the mesh tagged for subdivision;
generating, by the computing system, subdivided edge vertices based on edges of the mesh tagged for subdivision and the subdivided face vertices; and
generating, by the computing system, subdivided vertices based on vertices of the mesh tagged for subdivision, the subdivided edge vertices, and the subdivided face vertices.

4. The computer-implemented method of claim 3, wherein generating the subdivided edge vertices is based on smoothing rules, and wherein the smoothing rules are based on at least one of: an edge creasing weight of an edge to be subdivided and a number of incident faces to be subdivided.

5. The computer-implemented method of claim 3, wherein generating the subdivided vertices is based on smoothing rules, and wherein the smoothing rules are based on at least one of: a number of incident edges to be subdivided, a number of incident faces to be subdivided, an edge creasing weight of an incident edge to be subdivided, and an average crease weight of incident edges to be subdivided.

6. The computer-implemented method of claim 2, wherein causing generation of the tessellation is based on predefined tessellation rules associated with predefined cases of face configurations.

7. The computer-implemented method of claim 2, wherein causing generation of the tessellation is based on at least one of: a base case of a face that has one or two vertices, a base case of a face that has three face vertices, and a base case of a face that has more than three face vertices and no subdivided edge vertices.

8. The computer-implemented method of claim 2, wherein causing generation of the tessellation comprises:
identifying, by the computing system, a face vertex for a face to be subdivided that is a subdivided edge vertex for the face; and
generating, by the computing system, a subdivided face based on the subdivided edge vertex.

9. The computer-implemented method of claim 1, wherein the data associated with the mesh are based on a machine learning model, and wherein the machine learning model is trained to determine the data based on animation training data and parameters associated with faces, edges, and vertices of the mesh.

10. The computer-implemented method of claim 2, wherein the tessellation of the partially subdivided mesh is rendered in real-time.

11. The computer-implemented method of claim 1, wherein the data includes at least one of: a zero level associated with a polygonal face, edge, or vertex, a non-zero integer level associated with a level of subdivision, and a non-zero non-integer level associated with a fractional level of subdivision.

12. A system comprising:
at least one processor; and
a memory storing instructions that, when executed, cause the system to perform operations comprising:
determining data associated with a mesh of a three-dimensional object;
generating a partially subdivided mesh based on the mesh and the data.

13. The system of claim 12, the operations further comprising:
causing generation of a tessellation of the partially subdivided mesh.

14. The system of claim 12, wherein generating the partially subdivided mesh comprises:
generating subdivided face vertices based on faces of the mesh tagged for subdivision;
generating subdivided edge vertices based on edges of the mesh tagged for subdivision and the subdivided face vertices; and
generating subdivided vertices based on vertices of the mesh tagged for subdivision, the subdivided edge vertices, and the subdivided face vertices.

15. The system of claim 14, wherein generating the subdivided edge vertices is based on smoothing rules, and wherein the smoothing rules are based on at least one of: an edge creasing weight of an edge to be subdivided and a number of incident faces to be subdivided.

16. The system of claim 14, wherein generating the subdivided vertices is based on smoothing rules, and wherein the smoothing rules are based on at least one of: a number of incident edges to be subdivided, a number of incident faces to be subdivided, an edge creasing weight of an incident edge to be subdivided, and an average crease weight of incident edges to be subdivided.

17. A non-transitory computer-readable storage medium including instructions that, when executed, cause a computing system to perform operations comprising:
determining data associated with a mesh of a three-dimensional object;
generating a partially subdivided mesh based on the mesh and the data.

18. The non-transitory computer-readable storage medium of claim 17, the operations further comprising:
causing generation of a tessellation of the partially subdivided mesh.

19. The non-transitory computer-readable storage medium of claim 17, wherein generating the partially subdivided mesh comprises:
generating subdivided face vertices based on faces of the mesh tagged for subdivision;
generating subdivided edge vertices based on edges of the mesh tagged for subdivision and the subdivided face vertices; and
generating subdivided vertices based on vertices of the mesh tagged for subdivision, the subdivided edge vertices, and the subdivided face vertices.

20. The non-transitory computer-readable storage medium of claim 19, wherein generating the subdivided edge vertices is based on smoothing rules, and wherein the smoothing rules are based on at least one of: an edge creasing weight of an edge to be subdivided and a number of incident faces to be subdivided.
